(19) United States
(12) Patent Application Publication
(10) Pub. No.: US 2009/0288545 A1
(43) Pub. Date: Nov. 26, 2009

(54) Andantephone: Sequential interactive multimedia environment, device, system, musical sculpture, or method of teaching musical tempo

(76) Inventor: Steve (William George) Mann, Toronto (CA)

Correspondence Address: MICHAEL RIES, 318 PARKER PLACE, OSWEGO, IL, 60543, US

(21) Appl. No.: 12/257,385

(22) Filed: Oct. 23, 2008

Related U.S. Application Data
(60) Provisional application No. 60/981,926, filed on Oct. 23, 2007.

(51) Int. Cl. G09B 15/00

(52) U.S. Cl. 84/484

(57) ABSTRACT

A new way of teaching musical tempo and rhythm is disclosed, together with devices and systems for implementing it. A song-stepper moves through a song or other multimedia file a set amount for each footstep. For andantephonic songs, each step activates the next note in the song, so that there is perfect synchronization between the music and the speed of walking (i.e. if a player walks faster the song plays faster; if the player stops walking the song stops, etc.). The footsteps are sensed by pads such as patio stones arranged along a path. For example, walking to a garden causes a song to play in time with a person's footsteps. Portable versions of the invention are also disclosed. These use sensors installed in shoes, skates, skis, or toboggans.

This application claims priority to U.S. Provisional Application 60981926 filed 23-OCT-2007, the entire disclosure of which is incorporated by reference.

### FIELD OF THE INVENTION

The present invention pertains generally to a new kind of musical instrument or input/output device that may be used to control a musical instrument, or other multimedia system or events.

### BACKGROUND OF THE INVENTION

Existing musical instruments, sound production devices, musical devices, and the like, are generally either operated by a person, such as a musician, who plays the music, or they are automated, as with a player-piano, barrel organ, music box, Compact Disk player, or the like.

Some musical instruments allow for a combination of automation and user-interaction. For example, many children's instruments have a built-in rhythm and/or accompaniment generator, so that the children can select a song “STYLE” and play along with a partially computer-generated experience.

No existing musical input devices or instruments allow children or non-musicians to expressively and intricately vary the timbre, intonation, or other subtle aspects of each note played, without needing to know the notes of a song.

Thus children or non-musicians must choose between the tegical or mechanical sound of an automaton-generated or computer-generated acompaniment, or they must study an instrument such as the violin, for many years, in order to be able to play highly expressive music.

### SUMMARY OF THE INVENTION

The following briefly describes my new invention.

This invention solves the problem of making it fun and easy for anyone to create their own multimedia content with a great deal of temporaral and expressive creativity but without too much effort.

My invention solves this problem by way of wearable sensors (usually in footwear such as shoes, skates, skis, snowboard, or the like, or in a similar conveyance such as a toboggan, luge, surfboard, bodyboard, or bicycle) or by way of sensors along a path traveled by a participant, wherein each sensor can affect, trigger, or modulate multimedia content in sequence.

For example, a story unfolds, a video plays, or a song plays as a participant walks through the space. The rate at which the multimedia content is dispensed varies in proporition to the rate at which the participant moves (e.g. walks, swims, skates, skis, or the like) through the space.

In one embodiment the invention consists of a path along which there are pressure sensors. When a participant steps on a pressure sensor, a multimedia file goes to a particular index associated with that particular sensor. Stepping on the next sensor moves the multimedia file to the next index. If a person walks faster the indices move faster and the multimedia file plays faster. If the participant stops, the multimedia stops. If the participant walks backwards, the multimedia plays backwards. In this way, the participant has control over the multimedia. In some embodiments, if the participant steps down harder, the multimedia plays louder, and, in other ways, the participant can change the multimedia by the manner of stepping, thus, for example, being able to play a song very expressively, through the intricate control of recorded samples, synthesis, or other multimedia content generation, retrieval, or manipulation.

The invention may be used as a new way of teaching musical tempo. In this embodiment, no technology other than, for example, a piece of chalk and an a parking lot is required. The teacher begins by writing out the music on a timeline along the ground, with, for example, chalk, in a form in which each beat of the music corresponds to one footstep. The song is stretched out in time across the parking lot, and a participant can walk across and learn the time of the music.

In some embodiments of the invention, computer vision is used to track participants so that the music is actually generated by their footsteps moving through the space. In other embodiments patio stones, leading to a musical garden, are installed and each stone is outfitted with a pressure sensor. In some embodiments the pressure sensors are connected to a central computer, which is programmed to step through a song, as people walk to the garden. Each footstep activates the next note in the song, so that there is perfect synchronization between the music and the speed of a player's walking (i.e. if the player walks faster, then the song plays faster; if the player stops walking, then the song stops, etc.). In one embodiment the computer controls an outdoor pipe-organ sculpture such as a pipe organ made of plastic pipes. Another embodiment provides a Musical Instrument Digital Interface (MIDI) output to control a MIDI-controllable player piano, such as a Yamaha Disklavier Grand Piano, or Disklavier Upright Piano, or other MIDI-controllable sound-producing device such as a Yamaha PSRE303 synthesizer, or an OKI ML2870A surface-mount MIDI ringtone chip. Some embodiments of the invention are human-powered, either electrically, or wholly acoustically without the use of a computer.

Various musical compositions can be arranged for the invention, and a song can be chosen by a participant, and then subsequently performed.

The invention need not involve any devices, i.e. there are embodiments that are simply new methods of teaching music. The teaching method, together with various sculptural embodiments of it, help to break down social barriers and create cross-cultural and cross-generational ties.

Other embodiments of the invention include arrays of hydraulophonic fountain jets that play a song in a water park when a person walks on the water. Each note or beat is triggered by a water pressure increase when one of the water jets is blocked by the foot of a user stepping on it.

In other variations of the invention, the sensors are microphones, hydrophones, or geophones, and the participant's own footsteps form the initial sound, which is then passed through bandpass filters, frequency-shifters, or the like, to determine which note(s) of the song are played. For example, a row of 48 geophones (buried microphones) plays “Twinkle Twinkle Little Star” when, for example, the first two are connected through bandpass filter(s) and/or frequency-shifters tuned to 261.63 Hz (“C”), the 3rd and 4th geophone are connected through a 392 Hz filter (“G”), the 5th one is connected through a 440 Hz filter, (“A”), and so on. Thus the song's notes, C, C, G, G, A, A, G, . . . , play as the player walks along the path of the instrument.

In some embodiments the path may branch, allowing participants to change the storyline, movie, or song, by choosing from various a different paths as they walk through a garden.

In other embodiments, the path includes a closed loop, or is a closed loop, and paricipants can walk around a circle, square, or other similar path. In this embodiment, the invention may include means for counting the number of times the participant loops around, so that a new portion of the song can be played as the participant loops around. In some embodiments this is done by defining a matrix (two-dimensional array of numbers), in which each column corresponds to a particular sensor, and each row corresponds to a particular note. The number in each entry is typically a number from zero to 255 that indicates note volume. In a typical embodiment, there are sixteen sensor pads and 12 organ pipes in a computer-controlled pipe organ sculpture that hangs in a garden. The 12 pipes are for the notes A, B, C, D, E, F, G, a, b, c, d, e. Each pipe has an air proportioning system that allows wind to vary depending on the number fed to it. Each sensor pad generates a number from 0 to 1023 depending on how hard it is pressed. This input is multiplied by the element of the matrix, and fed to the 12 organ pipes. For example, suppose it is desired to play a C-major with emphasis on C for the first note of song with harmelodic C-C (C-major and C-note), the first column of the matrix contains 0, 0, 255, 0, 63, 0, 63, 0, 0, 0, 0, 0. Stepping on the first pad very lightly causes a small amount of wind to blow through the C-pipe and less to blow through the E and G-pipes. Stepping harder on the first pad causes more wind to come out of the C, E, and G pipes, with most of the wind coming out of the C-pipe.

Stepping on the next pad causes readout of second column of the matrix to control the pipes. Stepping on both first and second pads causes addition of the first two columns on an element-by-element basis to get a new sound-vector, 12 elements long, equal to the sum of the first two columns times the sum of the forces on the first two pads.

More generally, a processor computes, on a continuous basis, the inner product of a 16 element step-vector (vector of footsteps through the array of pads) and each column of the 16 by 12 matrix, resulting in a 12-element sound-vector, which continuously updates to the sound production device.

Quantities may be binary if desired. For example, the pads may simply be on/off switches such as those made by London Mat for control of carwash equipment or to open the rear doors of a bus when people stand on the mat. The sound equipment may also be binary, e.g. an electric solenoid activated glockenspiel or the pipes of a church organ, which are merely opened fully or closed fully depending on whether or not there is current on the solenoid.

When walking along a circular path the invention can reload the matrix. A matrix-reloader detects passage along the path and reloads the song matrix each time a person goes around the path. In this way, if a song has 64 beats per verse, it can be played on 16 pads, by having a matrix-reloader reload the matrix four times, once for each time the player walks around the path. In some embodiments selected pads, such as pads number seven and eight, mark the matrix for reloading, when a player presses seven and then eight in the proper order. Once a matrix-reload mark is set (after the player crosses pad 8), the matrix is ready for reloading, but does not get reloaded until the player finishes with pad sixteen. Then the matrix is instantly reloaded and ready as soon as the player reaches pad one.

In this way, for example, a song that requires 64 beats can be encoded onto 16 pads as four revolutions. During the first revolution, the first 16 notes are played. During the second revolution, the next 16 notes are played, and so on.

In some embodiments, a more robust way to operate the matrix-stepper is to monitor when more than half of the pads have been hit in sequence, and then to increment a song phrase counter when this happens. The song phrase counter thus counts from 1 to 4, as the participant walks around the loop four times.

We can think of this as operating a three-dimensional array (hypermatrix), with dimensions 4 by 12 by 16. The phrase counter controls the page of the matrix (stepping through pages 1 to 4).

Some embodiments of the invention are entirely acoustic. Other embodiments are merely user-interface devices. Many preferred embodiments use the acoustically-generated sound of a sensor pad (e.g. a geophonic pad, or geophones in the shoes of the player) as input to effects such as computerized processor or the like, in such a way that the overall instrument is not an electronic instrument but is more akin to a xylophone or other acoustically-originated instrument. In this way, rubbing the pad produces a sound similar to a violin, whereas striking it produces a sound similar to a xylophone or glockenspiel.

On some instruments the user-interface is a row of water jets. These may be arranged in a path, such as along a waterslide, so that going down the waterslide plays a particular song. At the top of the slide a bather can select a song, and then play it by going down the slide.

Some embodiments use an array of water bugles along a waterslide. Pitch control on the water bugle is done through the intricate interaction of the player's body with each jet/mouth of the instrument. Such an instrument resembles a giant woodwind instrument having many “mouthpieces” with water spurting from each of “mouth-piece”. Playing such an instrument gives rise to body-embouchure, in which the body of the player takes on the role of embouchure expression typically associated with wind instruments.

It is also a lot of fun to play music while playing in a fountain, and running one's fingers over the water jets is soothing—i.e. the invention can be used to combine music therapy with water therapy in retirement homes, or for use by special needs children, and the like, where a song is played out by simply running one's fingers along a row of water jets. The jets can also be built into a railing or the like, so as pool patrons wait in line to use a springboard or platform or other aquatic feature, they can play a song as they move along holding onto a pipe with holes in it.

Some embodiments generate the initial sound acoustically (i.e. sound is first produced acoustically and then later electrically modified). These embodiments bear similarity to an electric guitar, or electric xylophone, or electric piano, in the sense that it can be an acoustic instrument that uses electric processing, filtering, and amplification to increase the range of sounds but maintain a high degree of expressivity and intricacy of musical expression. As with electric guitar, it can be used with numerous effects pedals, computerized effects, guitar synths, hyper instruments, and the like, while remaining very expressive.

In some embodiments the output from each microphone, hydrophone, or geophone is run into a bandpass filter and/or frequency-shifter, tuned to the frequencies of the notes corresponding to the entries of a particular sound-vector.

By cascading a variety of different filterbanks, some embodiments achieve a rich and full sound that is still very expressive, but is easier to play, thus making the instrument suitable for permanent installation in public spaces where visitors can play the andantephone without the need for prior practice or special training.

Additionally, to further increase the playability an acoustic exciter, such as one or more geospeakers, hydrospeakers, or the like, is placed inside the instrument, causing feedback to occur. When combined with a bank of bandpass filters, this results in a tendency for the instrument to favor playing at or near the center frequency of each bandpass filter. As a result of this feedback, or exciation, the instrument becames alot easier to play “on key”, but still is sufficiently expressive. Thus there is still a sufficient ability to “bend” and sculpt notes, depending on how a person steps on or otherwise interacts with a sensor.

With the water spray, each beat of the song is a time-varying sculpture, in which slight pitch, vibrato, tremelo, timbre, and volume changes manifest themselves as visible changes in the water spray pattern experienced by both the player and his or her audience (e.g. other bathers in the vicinity).

Frequency-shifting can work in some ways similar to (but also in other ways different from) a superheterodyne radio receiver, where signals are downshifted and upshifted. In a preferred embodiment the frequency shifting is done logarithmically, rather than linearly, as it pertains to human perception.

In some embodiments much of this frequency-shifting is done using combinations of oscillators and modulators. In particular, a MIDI device is used for the oscillators, and thus some or all of the filterbanks in an andantephone installation can be implemented by way of MIDI devices. This is not the manner in which MIDI was designed to be used (i.e. MIDI is usually used for the production of sound rather than for the filtering or modification of already-existing sound), but certain behavior of certain MIDI devices can be exploited to produce the desired effects processing.

A curious side-effect of using MIDI-compliant oscillators to implement acoustic filterbanks leads to an embodiment I call durtngtouch. Duringtouch is the use of MIDI signalling for a smooth, near-continuous processing of audio from a microphones, hydrophones, or geophones for each beat on an instrument such as an andantephone.

Normally MIDI is used to trigger notes using a note-on command, at a particular velocity, perhaps followed by aftertouch (channel aftertouch or polyphonic aftertouch).

In duringtouch, however, the idea is to get a MIDI device to become a sound processing device. With many andantephone embodiments, there is no such thing as a note-off command, because all the notes sound for as long as the instrument is running. In preferred embodiments there is a continuous fluidity in which the sound though each footboard or footwear-based system and sounding mechanism causes each note to sound to some small degree even when the player is not pressing down on any pad or on his or her shoes.

When nobody is playing the instrument, it still makes sound from background vibrations in the earth, or the like. In fact, the gentle “purring” of the instrument is a soothing sound that many people enjoy.

The enjoyable soothing sound, which is basically the sound of every note playing faintly in the background, is something I call the “compass drone” of the instrument because it makes audible the compass spanned by the instrument.

Preferably all notes are sounding before, during, and after the user touches any of the pads or other input devices. The sum of this sound over all notes is called the andantephone's “compass drone”. Signals from pickups on each note of an andantephone can be processed to enhance, reduce, or modify the compass drone. When done via duringtouch, we are left with a computer-modified “duringdrone”.

The fact that notes “play” before anyone touches the instrument gives what we might call “beforetouch”. Thus, philosophically, the instrument tries to go beyond the idea that a note must come into existence and then be modified by aftertouch.

The concept of duringtouch does not exist within the MIDI standard. As a result, some prototype embodiments work on MIDI devices that can be “hacked”, “hijacked” or repurposed into use with hydraulophones. As well, existing MIDI commands can be uased to transmit data relevant to the filtering process, but the speed could have benefitted if there were MIDI commands specifically for duringtouch—that is, messages for smooth variation of MIDI sounds which continuously play (not based on Note on/off) and are smoothly modulated. Presently the most successful use of duringtouch is with the Yamaha PSRE303, and with the OKI ML2870A ringtone chip.

Some embodiments include circuits that downgrade from duringtouch to regular MIDI so that the andantephone can be used as a MIDI controller. But then the sound might no longer come from the geophonic sound production media, because the MIDI is no longer being used as a continuous filter. Thus a preferred embodiment uses a “hacked” PSRE303 or OKI ML2870A rather than converting to standard MIDI to ensure that the instrument is operating acoustically (i.e. whereby sound originates in the geophonic matter) and not merely as a user-interface.

Ideally the bandpass filters or frequency-shifters of the invention should not necessarily be tuned precisely to one frequency, perfectly “in tune” for each note. In fact it is desirable to have a small but nonzero amount of width in the passband, passed through each filter, because: (1) It allows expressive pitch bending on the instrument. Otherwise, if the player bent a note, the electronic output would abruptly go silent; (2) Width in the filter facilitates a system with a fast response time, owing to the time-bandwidth product (Heisenberg-related uncertainty limit); (3) A slighly wider passband allows more of the expressive sounds made by the geophonic media to be heard.

My invention has many possible uses, ranging from new methods of teaching multimedia storyboarding and music, to musical sculptures that can be installed in playgrounds, athletic facilities, waterparks, and the like.

Various embodiments are possible, such as a walking-path made of sensor pads, putting sensors in shoes or skates, or equipping a space or environment with other sensors such as computer vision or laser beams broken by a participant passing through, etc. One or more surveillance cameras may also be used to replace the pads, and make for andantephonic multimedia content based on computer vision or other forms of participant-tracking. As an alternative to surveillance, a sousveillance system (e.g. wearable camera) may be used. A cameraphone necklace worn by a player, for example, may track his or her egomotion to andantephonically step through content. Alternatively or additionally, accelerometers in the phone or elsewhere on the body of the participant may clock or otherwise operate the andantephone.

Andante is the Italian musical term for tempo that is “at a walking pace”. Of course people walk at a variety of different paces, and there is some variation, from perhaps 78 to 108 on the Wittner scale, in tempo that is still considered “andante”. Combining the Italian “andante” with the Greek word “phone” (meaning “sound”, a commonly used suffix for musical instruments), results in the etymologically correct term “andantaphone” to describe musical instruments (such as a wearable computer and special shoes) that play or adapt themselves to a walking pace.

Some embodiments of the invention are interactive sculptures that do not require a participant to wear any special hardware.

### BRIEF DESCRIPTION OF THE DRAWINGS

The invention will now be described in more detail, by way of examples which in no way are meant to limit the scope of the invention, but, rather, these examples will serve to illustrate the invention with reference to the accompanying drawings, in which:

FIG. 1 illustrates an embodiment of the andantephone built into shoes.

FIG. 2 illustrates the invention used as a new way of teaching music.

FIG. 3 illustrates an alternative geometric pattern, namely hexagonal tilings, upon which to base the andantephone invention.

FIG. 4 illustrates a circuitous song-specific curved-path embodiment of the invention.

FIG. 5 illustrates a whymsical reverse-emphasis arrangement of a song to help with re-iteration of identical notes.

FIG. 6 illustrates an andantephone installation in a home, where the andantephone is permanently installed.

FIG. 7 shows an arrangement of tiles that's ideal for programming songs with 3 or 6 beats per measure.

FIG. 8 illustrates an embodiment of the invention that can easily be programmed to play 3-beat and 6-beat songs as well as 4-beat songs.

FIG. 9 illustrates an embodiment of the invention that is arranged for the 24 tiles used out of a 64 tile circuit.

FIG. 10 illustrates a centralized acoustic sculpture, using pneumatic or hydraulic action.

FIG. 11 shows how chords are implemented on the acoustic sculpture.

### DETAILED DESCRIPTION OF THE PREFERRED EMBODIMENTS

While the invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

In various aspects of the present invention, references to “microphone” can mean any device or collection of devices capable of determining pressure, or changes in pressure, or flow, or changes in flow, in any medium, not just air. Thus a “microphone” in the broad sense may refer to a hydrophone, geophone, ionophone or similar device that converts pressure or pressure changes into electrical signals. Likewise the term “hydrophone” describes any of a variety of pressure transducers that convert changes in hydraulic pressure to electrical signals. Hydrophones may include differential pressure sensors, as well as pressure sensors that measure gauge pressure. Thus hydrophones may have a single “listening” port or dual ports, one on each side of a glass or ceramic plate, stainless steel diaphragm, or the like. The term “hydrophone” may also include pressure sensors that respond only to discrete changes in pressure, such as a pressure switch which may be regarded as a 1-bit hydrophone. Moreover, the term “hydrophone” can also describe both devices that only respond to changes in pressure or pressure difference, i.e. to devices that cannot convey a static pressure or static pressure differences. More particularly, the term “hydrophone” is used to describe pressure sensors that sense pressure or pressure changes in any frequency range whether or not the frequency range is within the range of human hearing, or subsonic (including all the way down to zero hertz) or ultrasonic. Similarly the term “geophone” is used to describe any transducer that senses or can sense vibrations or pressure or pressure changes in solid matter. Thus the term “geophone” describes contact microphones that work in audible frequency ranges as well as other pressure sensors that work in any frequency range, not just audible frequencies.

The terms “Earth”, “Water”, “Air” and “Fire” may refer broadly to the states-of-matter. For example, the Classical Element indicated by the term “earth” may refer to any solid matter. Likewise the term “water” may refer to any liquid such as wine, oil, hydraulic fluid, or the like. The term “hydraulic” also refers broadly to any pressurized or pressurizable liquid not just “hydro” (water). The Classical Element “Air” likewise may refer to any gas, and the Classical Element, “Fire” may refer to any matter in its plasma state, or any condition in which at least some matter is in a plasma state, or in which there may be a preferential conductance of electricity on one direction more than the opposite direction, in the presence of combustion.

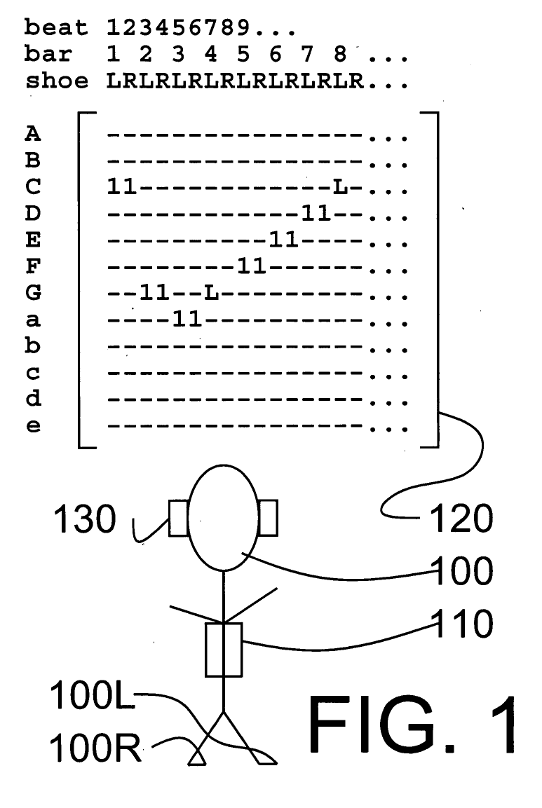

FIG. 1 illustrates an embodiment of the andantephone built into shoes 100L (left shoe) and 100R (right shoe) of a player 100. A processor is built into one or both of the shoes, or is borne elsewhere on the body of player 100, or is situated in the environment around the player 100. The andantephone may be built only into one shoe, or it can be built into both shoes. One or both shoes 100L and 100R may be equipped with a sensor, geophone, or the like. Processor 110 may be built into one shoe, in which case wireless communication with at least one of the sensors in a shoe may communicate with processor 110. Processor 110 may also be body borne in which case a wireless or wired communication with sensors in one or both shoes may run to processor 110.

Within processor 110 there is implemented an andantephonic stepper. The andantephonic stepper executes the steps of:
read from one or more footstep sensors;
estimate a steppiness quantity;
index through a multimedia file, by an amount proportional to the steppiness quantity.
   The steppiness quantity may be one of: an estimate of distance walked; an estimate of the number of footsteps taken; a mixture or factor of one of distance walked and number of footsteps taken.

In a preferred embodiment there is a matrix 120 called a song matrix. The matrix contains instructions for each note along a particular row. In the embodiment shown, there are 12 rows, each corresponding to one of the 12 notes in a musical scale from a 220 Hz “A” to a 660 Hz “e”.

Each column corresponds to a footstep, of left foot (odd numbered columns) or right foot (even numbered columns). The matrix 120 can be as wide as desired to accommodate however long a song might be. For example, the song matrix for the song “Twinkle Twinkle Little Star” is shown, in part. The portion shown corresponds to the lyrics “Twinkle twinkle little star (columns 1-8), How I wonder what you are (columns 9-16)”.

The song is expressed in “two time” (i.e. two beats per bar/measure). Thus eight full Left+Right walking cycles are shown. The entries are indicated as “1” (one) to indicate a note is sounded, and a minus sign (“−”) to indicate silence or a slightly negative sound level. A negative sound level is optionally useful when aggregating chords, so that it tends to bias the sound slightly below zero making it necessary to overcome a threshold with the footsteps to be heard. This optionally functions as a noise gate.

In simpler embodiments, notes are simply sounded when footsteps are made. The first step taken with the left foot is sensed by processor 110 which reads column 1 of the matrix 120 and retrives a “1” in row 3, so it plays the third note of the musical scale, namely “C”.

When the right footstep is taken by player 100, the processor detects this, and reads the second column which also indicates to play a “C”. Each note is rendered on the sound card of the wearable computer. A satisfactory embodiment of the sound card uses a sound chip having part number ML2870A, made by OKI semiconductor. The processor 110 prepends the number 5 to a suitable MIDI command, to indicate a write to register number 5 of the OKI ML2870A which causes the desired note to be rendered.

Player 100 listens through body-borne speakers or earphones 130.

The next step is a left footstep which indicates “G”. Thus the player, while wearing this apparatus, will play notes as follows:

### CCGGaaG+FFEEDDC+

where the plus signs indicate continuation of notes (longer-duration notes) notated in the matrix by the character “L” which is a code for “long” note. Other codes may be noted in the matrix, such as instrument or volume change. For example, the song matrix:

$$\begin{matrix}note & 123456789 … \\ bar & 1 \; 2 \; 3 \; 4 \; 5 \; 6 \; 7 \; 8 … \\ shoe & LRLRLRLRLRLRLRLR … \\ A & -- -- -- -- -- -- -- -- … \\ B & -- -- -- -- -- -- -- -- … \\ C & 21 -- -- -- -- -- -- 2 z … \\ D & -- -- -- -- -- -- 21 -- … \\ E & -- -- -- -- -- 21 -- -- … \\ F & -- -- -- -- 21 -- -- -- … \\ G & -- 21 -- 2 z -- -- -- -- … \\ a & -- -- 21 -- -- -- -- -- … \\ b & -- -- -- -- -- -- -- -- … \\ c & -- -- -- -- -- -- -- -- … \\ d & -- -- -- -- -- -- -- -- … \\ e & -- - -- -- -- -- -- -- - …\end{matrix}$$

indicates that the first note of each bar (measure) is to be louder. This helps give a nice rhythm that emphasizes the first beat of each measure, as in “TWINkle TWINkle LITtle STAR, HOW i WONder WHAT you ARE”.

The code “z” indicates a sustained rest, i.e. like a rest but holds the previously sounded note and lets it decay slower than otherwise (sustain, or the like).

As can be seen by anyone skilled in the art, various codes can be inserted into the song matrix.

Additionally, if desired, chords can be played. For example, the song matrix:

$$\begin{matrix}note & 123456789 … \\ bar & 1 \; 2 \; 3 \; 4 \; 5 \; 6 \; 7 \; 8 … \\ shoe & LRLRLRLRLRLRLRLR … \\ A & -- -- -- -- -- -- -- -- … \\ B & -- -- -- -- -- -- 21 -- … \\ C & 752121212121 -- 7 z … \\ D & -- -- -- -- -- -- 75 -- … \\ E & 2121 -- 21 -- 75 -- -- … \\ F & -- -- 21 -- 75 -- -- -- … \\ G & 2175 -- 75 -- 1 - 1 -- - … \\ a & -- -- 75 -- 1 -- -- -- - … \\ b & -- -- -- -- -- -- -- -- … \\ c & -- -- -- -- -- -- -- -- … \\ d & -- -- -- -- -- -- -- -- … \\ e & -- - -- -- -- -- -- -- - …\end{matrix}$$

indicates that note 1 (which sounds when the left foot first hits the ground) will actually be a chord, not just a single note. In particular it will be a strong C with a weaker E and G, resulting a C-major chord with an emphasis on the root member of the chord “C”.

Note 2 will be a slightly quieter version of the same thing, which will sound when the right foot hits the ground. Note 3, which will sound the second time the left foot hits the ground, will be the same chord as note 1 (C-major) but now the emphasis will be on the “G” member of the chord. Note 4 is a quieter version of this. Note 5 is an F-major (“C”, “F”, and “a”) with emphasis on “a”. As can be seen, the emphasis can be on any member of the chord, not just the highest note. This enables harmelody (intertwined harmony and melody on an overlapping compass).

Additionally, the force profile or pattern with which the foot hits the ground, as well as the manner (e.g. square on, or at an oblique angle, even scraping the ground rather than hitting it) can be captured by processor 110, and this extra information can be used to greatly change the sound, if desired.

For example, rubbing a foot along the ground can make the sound like a violin, whereas stomping square-on can be rendered like chimes, and hitting at an angle can be rendered like a clarinet. Because of the infinitely many ways of striking the feet against the ground, the player can play or “walk” a particular song in many different ways, adding subtle nuances to the sound.

This embodiment of the invention facilitates playing musical instruments while walking, so that the player gets a sense of tempo in the music. These musical instruments can be interfaces to a wearable computer.

One embodiment has piezo electric pads built into shoes to generate electricity for the wearable computer, as well as give it an awareness of tempo footsteps.

The invention can have music running at the tempo of the player's footsteps, by having a wearable computer configured so that each step advances to the next beat of music.

Alternatively, the wearcomp (wearable computer) can be programmed to step through MIDI music files, so that when walking faster the music plays faster, and when stoping the music stops.

Even if people do not know how to play a musical instrument, they get the sense that it makes them feel like they are generating the music. Not only are they generating the electricity to run the music, but they are, in a sense, “conducting” the music with their feet.

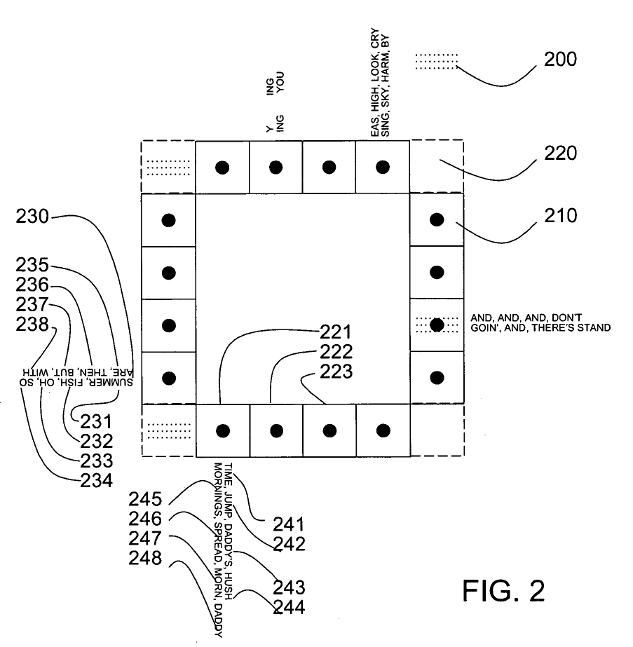

FIG. 2 illustrates a method of teaching music based on the invention. One method of andantephonic teaching involves the steps of:
breaking a song down into equal segments;
optionally andantephonizing the song (i.e. arranging it so each beat represents one note, or so that there are easily understood segments of it);
associating each segment with a real-world object such as a tile, or a certain distance along a parking lot, or the like;
indicating an element of the song such as note-to-play or the lyrics-to-sing while stepping on the segment.

The figure illustrates the lullaby “Summertime” written in sidewalk chalk on the granite slabs of Toronto's Dundas Square (often referred to as “Times Square North”, i.e. Canada's civic and cultural epicenter equivalent to Times Square in New York which is often regarded as America's or even the “world's stage”).

An andantephonic arrangement can be done anywhere people walk, swim, ski, skate, or the like. For example, it can be arranged up or down stairs, such as one step for each media segment (e.g. beat), or the like.

FIG. 2 depicts tiles 210 which are large nicely textured black granite slabs, each one approximately 35 inches by 35 inches square, as the sonels (sonic elements), much like pixels (picture elements) of an image. Each sonel has characteristics similar to a chalk board, in the sense that the slab has texture that readily accepts sidewalk chalk or the like. Human-readable or machine readable indicia 230, relevant to the song, are applied, one to each of some or all of the sonels. Sonel indicia may for example include notes to play, or lyrics to sing. In the case of machine readable indicia the andantephone may be implemented by a device that traverses the path and plays the song as it moves. Preferably such a device is human propelled. This could, for example, be a baby stroller that a user would push along the path. The stroller would have an instrument or sound synthesizer in it to play each sonel as it passes underneath.

In the case of a human user, directly using the invention, i.e. by walking and reading the indicia 230, as shown in FIG. 2, two verses of the song are shown by way of the first word of the song, marking 231. There are 16 tiles shown, in a closed-loop (square path) that exists within the natural 5-tile periodicity of Dundas Square (e.g. one fountain 200 every five tiles). Tiles 220 are not used as part of the andantephonic path. Tile 221 is the first tile, tile 222 the second, tile 223 the third, and so on, for a circuit of 16 tiles.

The first word of the song, “Summertime” begins on a pickup note, so “Summ” actually falls on the last tile (tile 16), and the first beat is the third syllable of the word, i.e. “ . . . time”, which appears as marking 241. The second line of the first verse begins with the word “Fish” (i.e. “Fish are jumping”), and begins at marking 232. Marking 233 denotes the first word of the third line, and marking 234 the first word of the last line. Marking 235 is for the first word of the second verse. Marking 236 is for the first word of the second line of the second verse. Marking 237 is for the first word of the third line of the second verse. Marking 237 is for the first word of the last line of the second verse. These are all pickup notes.

Markings 241, 242, 243, and 244 are all for the first beat of each line in the first verse, and markings 245, 246, 247, and 248 are for the first beat of each line in the second verse.

As can be seen, some of the tiles are marked and some are not. The ones not marked correspond to rests, or to places in the song where notes do not fall directly on tiles. Walking around the circuit, counterclockwise four times, plays the first verse and another four times the second verse. The song gets played when a person walks around and sings the words as they step on them. The in-between words are sung, and the words written are simply to keep track of correct tempo, rhythm, and timing.

Additionally some embodiments of the invention use cameras and computer vision to sense footsteps, and step through various songs, such as my arrangement of the Gershwin lullaby.

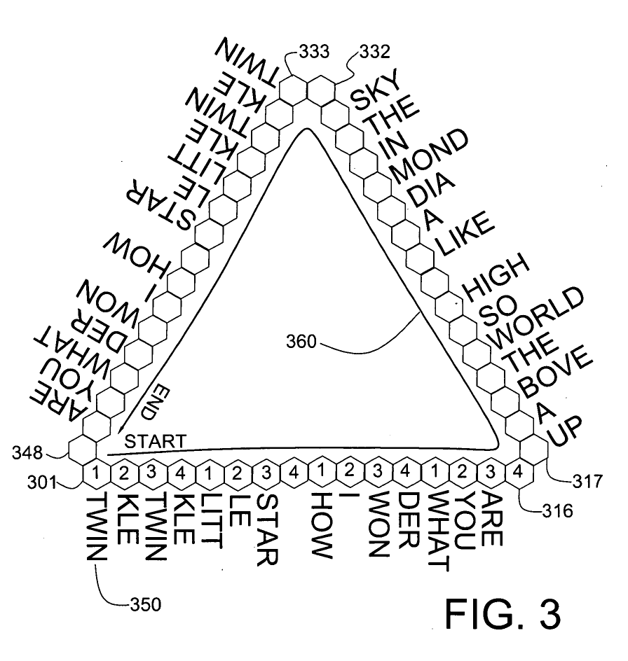

FIG. 3 illustrates an alternative geometric pattern, namely hexagonal tilings, upon which to base the andantephone invention. Gershwin's lullaby (“Summertime”) is not a very andantephonic song, i.e. the notes are of vastly differing note durations, as with many intricate jazz songs. Thus with Summertime, sonels do not correspond directly to notes, but the song can still be broken up into equal segments (sonels) nonetheless.

Some songs like “Twinkle Twinkle Little Star” for example, are almost entirely andantephonic in their original form. Thus, for the most part, each sonel is one beat that corresponds to one note (except for the longer notes at the end of each 8-beat phrase).

Each verse of the song has 48 beats. FIG. 3 shows a sound space with a hexagonal tiling in which the first tile 301 has marking 350 of the first syllable, “TWIN” of the first word of the song, “TWINKLE”. The first 16 tiles 301 to 316 are arranged in a row, then the next 16 tiles 317 to 332 are in a row, and the last 16 tiles 333 to 348 in a row, to form a triangular circuit. Each tile corresponds to one note of the song.

Electric generators (Piezeoelectric crystals) or pressure transducers are attached to the underside of each of the 48 active tiles which are hexagonal patio stones. Preferably each tile generates electricity when stepped on, and drives a signaller to wirelessly convey the amount generated, as well as the manner in which the tile was hit, etc., for an expressive control.

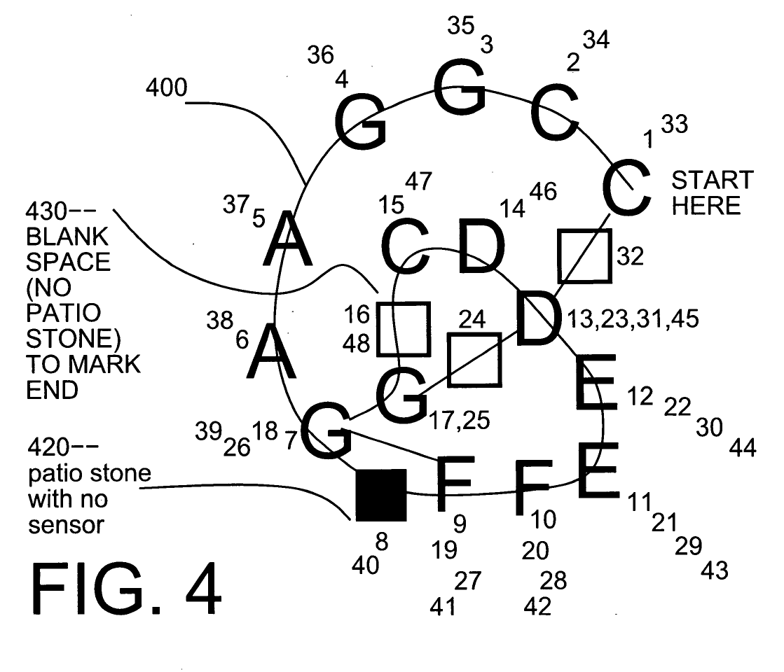

FIG. 4 illustrates a circuitous song-specific curved path for implementation of Twinkle Twinkle Little Star in a garden. It contains the following:
A total of 16 patio stones;
A totel of 15 sensors (one patio stone 420 has no sensor);
Three blank spaces upon which a person steps. The blank spaces are for rests, although they're not marked with stones.
Total of 3 C-stones (stones that sound the note “C” when stepped on);
Total of 2 D-stones;
Total of 2 E-stones;
Total of 2 F-stones;
Total of 4 G-stones;
Total of 2 a-stones (stones that sound the note “a” when stepped on).

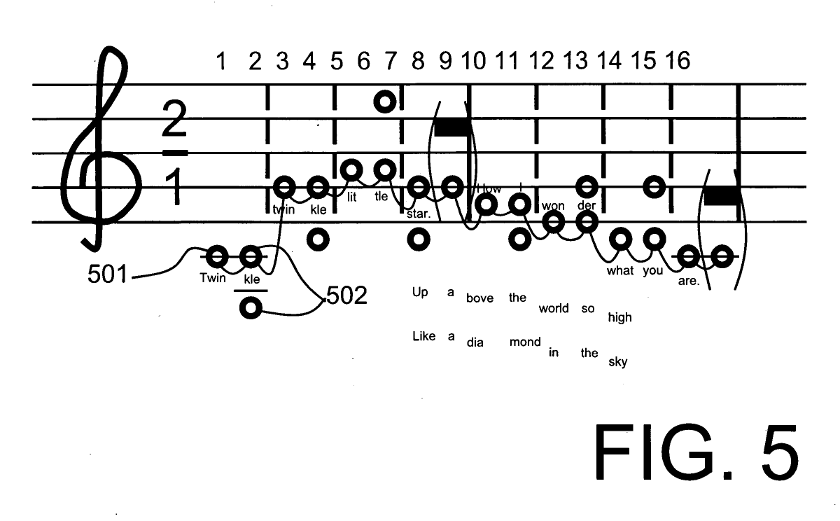

FIG. 5 illustrates a whymsical reverse-emphasis arrangement of Twinkle Twinkle Little Star for a pipe organ, in which note 501 is turned on when the player steps on the first tile, and then chord 502 is turned on when the player steps on the second tile, and so on. This reverse emphasis helps to disambiguate re-iteration of notes, on instruments such as pipe organs that don't re-enunciate notes as well. Thus the emphasis is on the second beat of each two-beat measure, as in: “twinKLE twinKLE litTLE star, how I wonDER what YOU are”.

On the way to the gardens there is a curved path of patio stones in the grass. Because the grass is damp, owing to the in-grass automated irrigation system, people usually step on the stones to walk to the gardens, so that they don't get their feet wet in the damp grass. Since people generally walk on the patio stones, one stone at a time, this is an ideal setting for a musical sculpture in which notes are triggered in a pre-determined sequence, by footsteps.

Rather than the geometric patterns of FIGS. 2 and 3, which were chosen to facilitate reprogrammability of the songs, the installation of FIGS. 4 and 5 is a more organic song-specific path.

When people walk along the path defined by the stones, their footsteps step them through a song. If more than one person is on the path, a nice musical “round” results. As people walk on the slabs they “step out” the song by way of a computer-controlled pipe organ sculpture made from grey PVC electrical conduit pipes hanging from a tree adjacent to the garden.

Sounds are produced by a computer controlled pipe organ sculpture made from grey PVC electrical conduit pipes hanging from a tree adjacent to the garden. PVC was chosen as a material for the construction of organ pipes, because it resists the harsh weather conditions. The sound comes out the bottom of the pipes, whereas the top is sealed against rain and snow.

One of the interesting observations made on the sculptures, is that when two successive notes of the song are the same, there needs to be some way to define a break in the notes. In particular, the problem arises when a person steps on one stone, and then the next, without stepping off the first stone before stepping on the next one.

This problem can be solved by putting the stones further apart, or by way of computer with beat-tracking. However, a more creative yet natural way of attaining a break in one long note, is to insert what I call “grace harmony”. Grace harmony works like the grace notes in bagpipe music, and serves to break up a long note into smaller pieces. My arrangement of the simple children's song, Twinkle Twinkle Little Star, for the garden sculpture, as shown in FIG. 5, uses this grace harmony.

Grace harmony breaks-up sequential occurrences of the same note: Here an unusual harmony provides a whimsical reverse-emphasis, by coming in during the second beat of each bar, i.e. “twinKLE twinKLE litTLE star . . . ”. Since the harmony comes in late (i.e. in a repeated melody note), additional creative opportunity exists to have it ride above the melody at times, without the risk of having it start the bar off on the wrong note. In this simple song, each foot step corresponds to one whole note, hence the time signature of 2/1, in which each bar of music contains both a left footstep and a right footstep. Note that I've used non-standard harmony at time-index 4, 6, and 7, rather than making the grace harmony from C, F (or C), and C, that would more expectedly form part of the chords for C-major, F-major, and C-major. The unusual harmony is in keeping with the spirit of a garden sculpture, suggestive of the playful harmony one hears from wind chimes.

The andantephones described so far, are either sculptures designed to play only one specific song, or have been illustrated using the example of only one specific song.

I now describe a more general form of andantephone that can be programmed for a wide variety of songs.

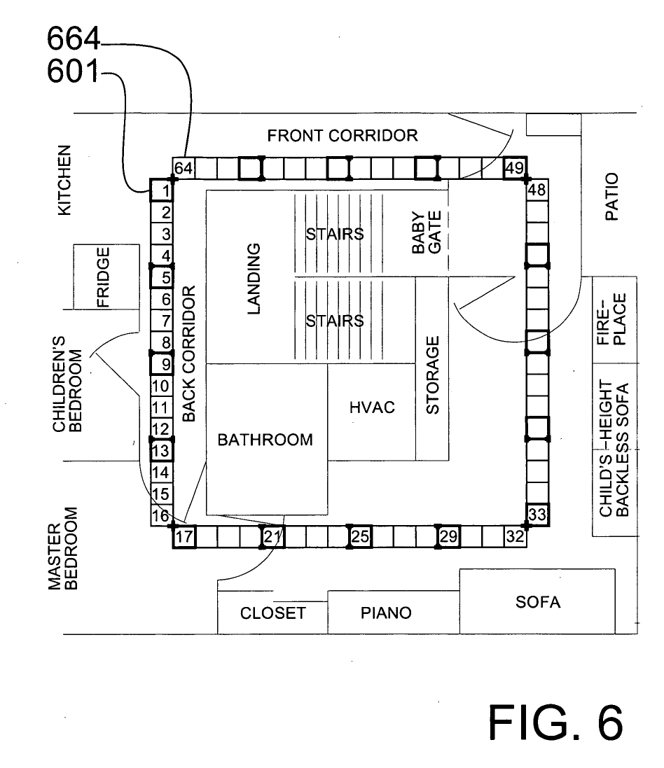

FIG. 6 illustrates an andantephone installation in a home, permanently installed to teach children music. This sculpture is not limited to only one song. It is constructed in a way in which it can be programmed with a variety of songs. I has 64 textured non-slip but durable tiles, running down the center of corridors that run around the house in a square shape. It has been designed around the stairwell and bathroom that already formed a central “island” in the dwelling, making use of the island to define an endless path on which one can walk around and around.

The instrument is designed to play, starting from the kitchen, where one might play just before or after dinner. There are 16 tiles running down the center of the corridor that runs from the kitchen to the bedroom, then another sixteen tiles running through the corridor into the living room, sixteen more tiles that run through the living room to the entrance hall, and finally another sixteen tiles that run from the entrance hall back to the kitchen. This arrangement results in a perfect square with sixteen tiles on each side of the square.

There are 64 tiles, starting from tile 601 and finishing at tile 664, arranged in a square circuit, in which every fourth tile is emphasized to construct one bar (measure) of music. The tiles are made of solid porcelain, with a non-slip textured surface. Each tile is a chalk board so that words from the song's lyrics can be written on any desired tiles, to begin the day's music lesson once the song is programmed. When it is time for a new music lesson, a new song is programmed, the “chalkboards” are erased with a standard floor mop, and new text is drawn in fresh chalk.

Many children's songs have four beats to every measure (four beats to every bar of music), so each side of the square represents four measures, which is typically one phrase, i.e. there are:
four beats (four tiles) per bar;
four bars per side of the square;
four sides of the square per revolution (once around the house).
   Thus, for many songs, each verse of the song represents a distance once around the square, so that each time the player reaches the kitchen the apparatus of the invention moves to the next verse of the song.

The tiles are made of solid porcelain, set in concrete. The top of each tile is textured to create a nonslip surface, as well as to allow it to function like the slate on a chalk board. When the andantephone is programmed with a particular song, the lyrics are either be projected onto the tiles, using data projectors, or, alternatively sidewalk chalk is used to write lyrics of the song, spread out along the tiles. The cement floor makes it easy to erase these 64 miniature chalkboards with a standard mop.

Other re-configurable andantephones use translucent tiles with rear-projection.

The layout, depicted in FIG. 6 for the indoor sculpture is suitable for most simple songs, that have two or four beats per measure, i.e. songs in “2/4” or “4/4” time. Usually people think of a quarter note as the basic unit of time for one beat. In using this invetion, however, for simplicity, time signatures are often normalized to one whole note. This also makes it easy for children to draw “circles” on the musical staff to represent notes, since many children's songs contain notes that are mostly of the same duration. The resulting time signatures than become “2/1”, “4/1”, etc. It is certainly easier to explain to a two-year-old that a whole square tile or whole round patio stone is a whole note, than it is to explain that a whole tile or stone is actually a quarter of a note.

Unfortunately certain other songs, such as “The Ants Go Marching”, “House of the Rising Sun”, and “Amazing Grace” do not fit onto the present powers-of-two tiling scheme, because these songs have three or six beats per measure (not a power of two). These songs are said to be in “3/4” or “6/8” time, which I will normalize to “3/1” and “6/1” when drawing circles on the musical staff for simplicity.

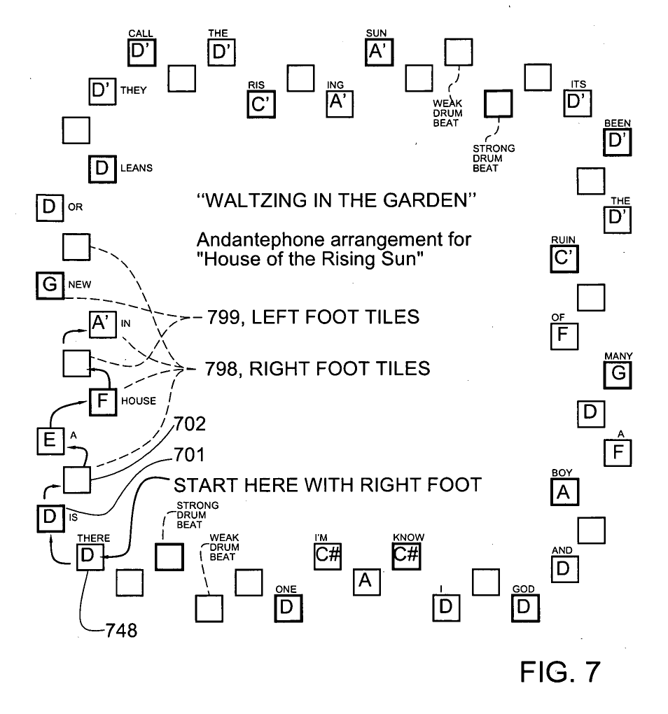

FIG. 7 shows an arrangement of tiles that's ideal for programming songs with 3 or 6 beats per measure. The tiles in this sculpture are arranged in a square that has 12 tiles on each side, for a total of 48 tiles.

The 48-tile andantephone is suitable for most songs that have three beats per measure: In this illustration, the song “House of the Rising Sun” is shown. The letters inside each tile indicate the note that plays when the tile is stepped on (chords are not shown for this arrangement). The processor is programmed to play the notes louder for the tiles that are indicated as bold squares, and quieter for those indicated by non-bold squares. Alternatively, chords can be assigned to these bold-square tiles, to define an emphasis as compared with the other tiles. In this particular arrangement, there is no percussion except for four of the tiles, two of which activate a weak drum beat, and the other of which activates a strong drum beat, as indicated. These drum beats serve to maintain the footstep tempo during rests. The layout of tiles encourages a swaying back in forth of the body while walking, in order to be suggestive of a waltz, since House of the Rising Sun can readily map to a waltz (i.e. 3 beats per measure).

The song begins on tile 748 which is the last tile of the circuit, since this is a pickup note which is indicated with indicia for the word “THERE”. The first note of the first bar is the word “IS” on tile 701. The second tile, tile 702 is a rest, and so on, i.e.:

“there IS 0 a HOUSE 0 in NEW 0 or LEANS . . . ” where emphasized (loud) beats are capitalized and rests are denoted as zeros.

It would be nice to have one sculpture that can be programmed for a variety of different songs, where some of the songs are in 4/4 (or 4/1) time, whereas others are in 3/4 (3/1) or 6/8 (6/1) time. Obviously one could simply just use the first 12, 24, or 48 of the 64 tiles, but then the start of the second verse of the song would no longer line up with the beginning (tile number t in the figure), i.e. each verse would no longer be a circuit in register with subsequent verses.

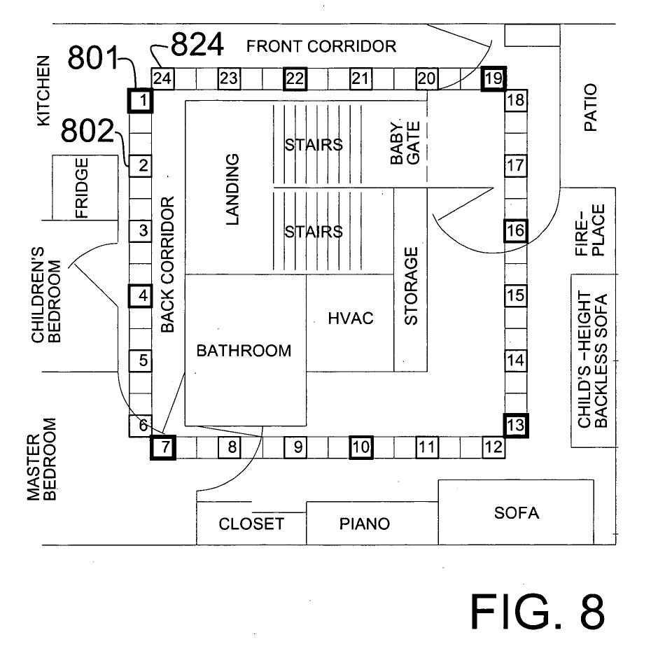

FIG. 8 illustrates an embodiment of the invention that solves this problem, using modifications to the indoor sculpture, so that it can easily be programmed to play 3-beat or 6-beat songs as well as the 4-beat songs it did before. The required change involves only using six of the tiles on each side of the square, and taking larger steps, as illustrated in FIG. 8.

Tile 801 is the same as tile 701 of FIG. 7. But tile 702 is not used. Instead the user jumps to tile 802 which would have been the fourth tile of FIG. 7. Continuing in this way, tiles are skipped in a similar way. Eventually the player ends on tile 824, which is tile number 24 of the circuit, corresponding to tile 764 of FIG. 7 (tile number 64 of the circuit in FIG. 7).

Using the 64-tile andantephone sculpture for songs in 3/4 (3/1) or 6/8 (6/1) time: Six tiles on each edge of the square are used, for a total of 24 tiles.

Children often enjoy the fun of jumping over tiles to make the larger steps required of this re-programming of the sculpture, especially with fast songs in 6/8 time such as Tarantella Dance, which results in very fast running around the house.

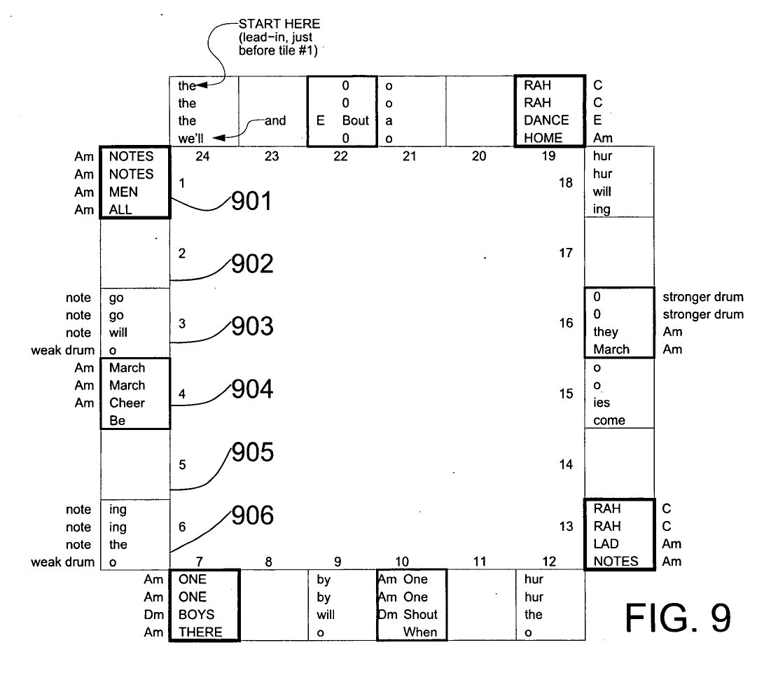

FIG. 9 illustrates an embodiment of the invention that is arranged for the 24 tiles used in FIG. 8 or for any other 24-tile circuit.

Consider for illustration an example of programming for six of the sixteen tiles on each edge of the square of FIG. 7, i.e. for six tiles per side of the square, a simple song that I adapted from the popular nursery rhyme “The Ants go Marching” (based on “Johnny Comes Marching Home”, which is itself based on the Irish folk song entitled “Johnny I Hardly Knew Ye”).

I slightly changed the lyrics to suit the andantephone's “marching notes” theme, and came up with the following:
The notes go marching one by one, hurrah! hurrah!
The notes go marching one by one, hurrah! hurrah!
The men will cheer, the boys will shout, the ladies, they will dance about, and
We'll all be there, when notes come marching home.

To program this song, I decided to use a chord at the beginning of every non-rest barline, in order to exaggerate the sense of rhythm. I also programmed it so that the chords at the corners of the square are louder, and those at the edges, less so. The resulting emphasis is shown below, with capitalization:

| | | | | | | |
|---|---|---|---|---|---|---|
| Am | Am Am | Am | C | drums | C | drums |
| The NOTES | go March-------ing ONE | by One, | hur-RAH, | o-0 | hur-RAH | o-0. |
| Am | Am Am | Am | C | drums | C | drums |
| The NOTES | go March-------ing ONE | by One, | hur-RAH, | o-0 | hur-RAH | o-0, |
| Am | Am Dm | Dm | Am | Am | E | E |
| The MEN | will Cheer, the BOYS | will Shout, | the LAD | ies They | will DANCE | a-Bout, and |
| Am | no chord Am | no chord | Am | Am E | Am | |
| we'll ALL | Be THERE | When | NOTES | come March-----ing | HOME | o-0 |

FIG. 9 shows the use of six tiles on each edge of a square path, for a total of 24 tiles. In this illustration the tiles are shown adjacently, rather than as depicted in FIG. 7. Since each verse of the song contains 96 beats, playing the first verse of the song requires walking around the island (circuit) four times.

Thus there are four words written on each tile. For example, the first tile has the words “NOTES”, “NOTES”, “MEN”, and “ALL” written on it. Note that these words are written so that they will appear right-side-up when walking from the kitchen to the master bedroom. However, for simplicity, all of the words are shown in the same orientation in this illustration, contrary to how they appear in reality.

In the text, words are capitalized to fully emphasize, and only the first letter is capitalized for words that are somewhat emphasized. These lyrics are written in chalk, on the tiles, at the beginning of a music lesson.

The music programming plays alternating strong and weak chords to define a rhythmic beat. Drums are sounded only when rests occur within the beat pattern, as indicated, where a weak drum is sounded in place of a note, and a stronger drum is sounded in place of a chord. The symbol “o” is used to denote a weak drum-rest, and the symbol “0” is used to denote a strong drum-rest.

The programming of the tiles is as follows: The song starts on tile 24, which sounds a pickup note (lead-in note), just before the first bar of music that starts on tile 1. Each bar of music is formed by six tiles on a side of the square. In 6/8 time, each of these six tiles represents an eighth note. Lyrics of the song are written in chalk, on the tiles, at the beginning of a music lesson.

Tiles are programmed as follows:
Tiles 1, 7, 13, and 19 (the ones drawn in bold lines) play a loud chord, together with a note of the melody. These tiles correspond to the first note in each bar. Words of the song that are written on these tiles are written in all capital letters, so that the children know that these words are to be strongly emphasized when they sing along with the computer-generated music. For example, the first tile has the words “NOTES”, “NOTES”, “MEN”, and “ALL” written on it. Note that these words are written so that they will appear right-side-up when walking from the kitchen to the master bedroom. However, for simplicity, all of the words are shown in the same orientation in this illustration, contrary to how they appear in reality.
Tiles 4, 10, 16, and 22 (the ones drawn in medium-thickness lines) correspond to exactly half way through the bar of music. These tiles play either a medium strength chord with a note of the melody or a medium strength drum during a rest in the melody. The drum sounds only when there is no note or chord playing, and this serves to give the children a sense of the passage of time, as well as a sense of consistency (i.e. these tiles always produce sound when they are stepped on, even if no notes are happening then). These percussive rests occur on tiles 16 and 22 during the first two lines of the song, and on tile 22 during the last line of the song. Words of the song that are written on these tiles are written in mixed case (i.e. with the first letter of the word capitalized), so that the children know that these words are to be slightly emphasized when they sing along with the computer-generated music.
Tiles 24, 3, 6, 9, 12, 15, 18, and 21 play either an individual note of the melody, or a weak drum sound, except that tile 18 plays a chord in only the last line of the song (only once near the end of each verse). The weak drum sounds only when there is no note being sounded. This serves to give the children a sense of the passage of time, as well as a sense of consistency (i.e. these tiles always produce sound when they are stepped on). Words of the song that are written on these tiles are written in lower case, so that the children know that these words are to be less emphasized when they sing along with the computer-generated music.
Tiles 2, 5, 8, 11, 14, 17, 20, and 23 make no sound when they are stepped on, except at the end of the third line of the song, where tile 23 just makes one note when it is stepped on, but only once in each verse of the song. On average tile 23 only makes sound a 25% of the time that it is stepped on.

The invention covers many different kinds of andantephones that work by way of a wide variety of different technical design principles. They are broadly categorized as:
Wearable: implemented in shoes, skates, skis, or the like;
Distributed: each stone or slab has its own sensing and sound-producing mechanism. There need be no connection between stones. This allows the stones to be moved around in the garden. Examples of distributed andantephones include:
   a small Atmel AVR microcontroller potted in epoxy to make it waterproof. The microcontroller drives a waterproof speaker under each stone. A simple sound synthesis algorithm generates a musical tone when a person steps on the stone;
   a bell or gong that is activated by stepping on it;
   a wind-blown or water-blown organ pipe in a hollow cavity under each stone. The organ pipe is activated pneumatically, hydraulically, mechanically, or electrically, sometimes with a small microcontroller in each slab to activate the organ pipe.
Centralized: a sensor in each stone is connected to a central processor that generates the sound. Examples include:
   a pneumatic bellows for each stone, supplying wind to a central pipe organ sculpture. One-way valves are used for each supply of wind going to one or more organ pipes. This arrangement allows a small number of organ pipes, for example, eight organ pipes, to be used by a large number (e.g. 64) of tiles;
   a water jet associated with a water jet on each slab, hydraulically connected to a central bank of acoustic hydraulophones;
   a pressure sensor for each slab that connects to a central computer that synthesizes the sounds;
   a pressure sensor for each slab that connects to a central processor controlling an acoustic instrument. The pressure sensor typically sends a mechanical, pneumatic, hydraulic, or electrical signal to the central processor, which then process this signal into sound. For example, an electrical sensor on each slab is often used to control an acoustic wind-blown sculpture.

Distributed andantephones generally consist of slabs where each slab always produces the same note and/or chord each time it is stepped on. This means that the granularity of the music cannot be finer than one beat per slab. So if a song is in “4/4” time, and we define each slab as a quarter note, there can be no eighth notes in the song.

Centralized andantephones allow notes that have shorter duration than the foot-step note duration. So if a song is in “4/4” time, and we define each slab as a quarter note, we can also include some eighth notes, sixteenth notes, etc. This is done by a tempo-tracking algorithm. However I prefer to avoid using too much sub-footstep timing, because it takes away from the illusion of simplicity that otherwise occurs when each note corresponds to one footstep. Sub-footstep timing also takes away fine control over the amplitude expression, because each note can no longer be stomped out with a unique amount of force, velocity, and pressure.

In many of the sculptural embodiments, electrical actuation by way of an analog pressure signal with 10-bit, 12-bit, or 16-bit precision is used. This allows, for example, 65535 different pressure levels to be conveyed to the processor. The differences in pressure affect the amount of chiff, the overblow of organ pipes, in organ-based embodiments, and other aspects of the sound, so that the instrument can be very expressive.

These degrees of fine control over the musical expression allow the user to stomp harder on some pads than others, in order to impart a unique expression to a particular performance of a song. The use of pressure sensors allows the instrument to be velocity-sensing (by way of taking the derivative of the signal) as well as displacement-sensing, acceleration-sensing, and so on.

This degree of musical expression goes beyond the standard musical keyboards that often respond primarily to velocity.

For example, sometimes the andantephone is set up to control both an organ and a piano at the same time. The piano responds to the dynamics of velocity (how fast one stomps on the sensors) whereas the organ responds to how hard one presses down on the sensors. Whether controlling acoustic instruments, or synthesizing sounds, maintaining velocity, force, and displacement sensing allows a nearly infinite degree of musical expression to take place.

Thus although the song is usually pre-scripted, in terms of which notes will be played, the way it is played can vary widely in terms of tempo, dynamics, and various forms of footstep-induced expression.

With regards to programming an andantephone, first consider songs that have entirely (or at least mostly) one note per beat. These are the easiest to program, and serve as good examples for illustrating this invention. Programming begins with an arrangement of the song. Consider, for example, a simple nursery rhyme like “Mary had a little lamb”. I first lay this out in a table, as shown below, where note-rests are denoted “o” and chord rests as “0”.

| Tile | | | | | 2/ | 4/ | 8/ |
|---|---|---|---|---|---|---|---|
| # | lyric | chord | note | foot | time | time | time |
| 1 | MAR | loud C | e | L | 1 | 1 | 1 |
| 2 | y | | d | R | 2 | 2 | 2 |
| 3 | HAD | quiet C | c | L | 1 | 3 | 3 |
| 4 | a | | d | R | 2 | 4 | 4 |
| 5 | LIT | medium C | e | L | 1 | 1 | 5 |
| 6 | tle | | e | R | 2 | 2 | 6 |
| 7 | LAMB | quiet C | e | L | 1 | 3 | 7 |
| 8 | o | | o | R | 2 | 4 | 8 |
| 9 | LIT | loud G | d | L | 1 | 1 | 1 |
| 10 | tle | | d | R | 2 | 2 | 2 |
| 11 | LAMB | quiet G | d | L | 1 | 3 | 3 |
| 12 | o | | o | R | 2 | 4 | 4 |
| 13 | LIT | medium C | e | L | 1 | 1 | 5 |
| 14 | tle | | g | R | 2 | 2 | 6 |
| 15 | LAMB | quiet C | g | L | 1 | 3 | 7 |
| 16 | o | | o | R | 2 | 4 | 8 |
| 17 | MAR | loud C | e | L | 1 | 1 | 1 |
| 18 | y | | d | R | 2 | 2 | 2 |
| 19 | HAD | quiet C | c | L | 1 | 3 | 3 |
| 20 | a | | d | R | 2 | 4 | 4 |
| 21 | LIT | medium C | e | L | 1 | 1 | 5 |
| 22 | tle | | e | R | 2 | 2 | 6 |
| 23 | LAMB | quiet C | e | L | 1 | 3 | 7 |
| 24 | its | | e | R | 2 | 4 | 8 |
| 25 | FLEECE | loud G | d | L | 1 | 1 | 1 |
| 26 | was | | d | R | 2 | 2 | 2 |
| 27 | WHITE | quiet C* | e | L | 1 | 3 | 3 |
| 28 | as | | d | R | 2 | 4 | 4 |
| 29 | SNOW | medium C | c | L | 1 | 1 | 5 |
| 30 | o | | o | R | 2 | 2 | 6 |
| 31 | 0 | drum 0 | 0 | L | 1 | 3 | 7 |
| 32 | o | | o | R | 2 | 4 | 8 |

*This chord may seem “wrong” to persons more familiar with the usual chord progression of the “1, 2, 3, 4” tempo, but serves to create the “1, 2” tempo, in which the finer granularity of the chord progression more closely follows the melody (i.e. the note “e” is a member of the chord “C” but not “G”). Removing all of the quiet chords would make the melody match what most people are familiar with, i.e. to emphasize only every 4th beat, so the volume of the quiet chords is set low enough that the “1-2-1-2- . . . ” effect is as subtle as desired.

This song uses 32 tiles, so if it is being programmed on a 64-tile andantephone, simply repeat the song twice (i.e. do two verses for each revolution around the andantephone). In the case of a large outdoor linear andantephone, perhaps the number of tiles used (i.e. whether or not you can keep going around for each verse) is less important.

Let us suppose that, for this arrangement, we wish to have a strong walking beat. We an achieve this by alternating chord, note, chord, note, and so on. Thus if you begin with your left foot, then, for this particular arrangement, each time your left foot hits a tile, a chord (or rest) will play. Each time your right foot hits a tile, only an individual note (or rest) will play. This creates a sense of 1-2-1-2-1-2 . . . timing.

Moreover, each four steps has medium accentuation, so the sculpture also expresses an element of 1-2-3-4-1-2-3-4- . . . timing.

Additionally, each eight steps has a strong accentuation, so the sculpture also expresses some degree of 1-2-3-4-5-6-7-8-1-2-3-4-5-6-7-8- . . . timing.

The next step in programming is to encode this table into the sculpture.

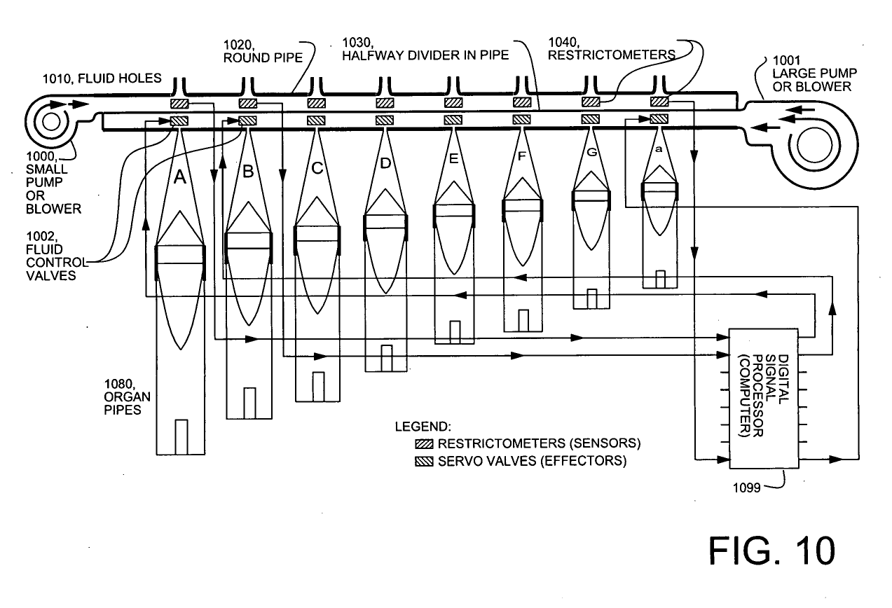

FIG. 10 illustrates a centralized acoustic sculpture, using pneumatic or hydraulic action. This sculpture has eight hydraulically modulated organ pipes that provide the notes of a natural minor scale. Songs in a major key often start on the third pipe (“C”). A digital signal processing system is used merely for process control, to achieve system stability, and to provide some fluid amplification. In all regards this is a truly acoustic musical instrument with the full expressive capability to capture the nuances in the different ways that people step on each of the hydraulic actuator pads.

The sound sculpture uses a signal pump 1000 which may be a small pump or blower for air or water or other fluid that is used for signaling. Small pump 1000 supplies fluid to restrictomers 1040 in a round pipe 1020 that has a halfway divider 1030 that divides a signal half from a sounding half. The top half is the signal half which uses low-flow at low-pressure, and the sounding half is the bottom half which uses high flow at high pressure, supplied by large pump 1001 which may be a large pump or blower or the like. A Digital Signal Processor (DSP) computer 1099 controls the system, such that small signaling fluid control can actuate very large sound levels in organ pipes 1080 if desired.

In this case, each tile has a small hose emerging from it, and the song is programmed by way of a small patch bay using “one touch” pneumatic (or hydraulic) fittings, electrical connections, or software.

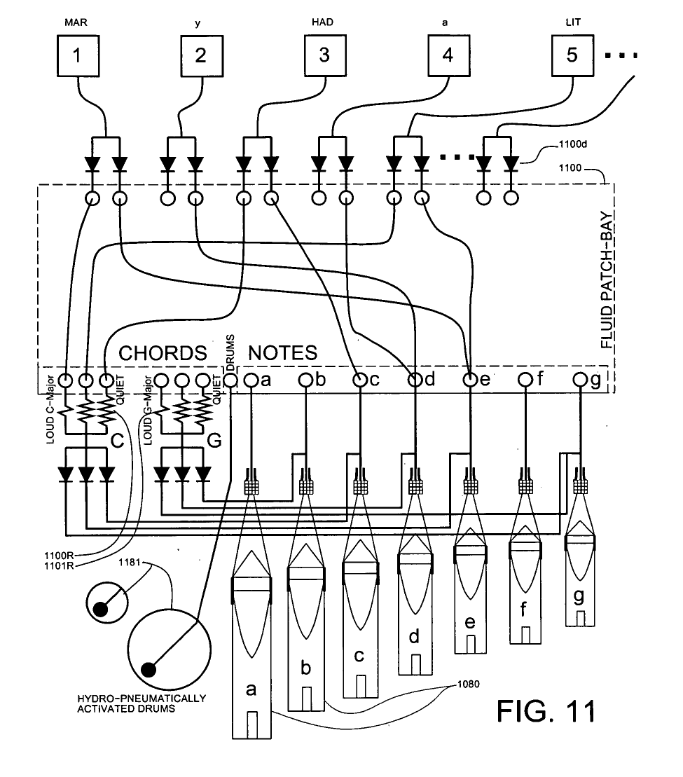

FIG. 11 shows how chords are implemented by having a three or four port fluid manifold for each chord.

A hydraulic patch bay 1100 is either real or virtual (computer-generated). A song is programmed into the sculpture by connecting hoses in the patch bay as illustrated, either actually, or virtually (by software). When using real hoses, one-way valves prevent reverse flow. When electrically actuated, these are diodes 1100d.

Reverse-prevention valves keep fluid flowing in the proper direction. Flow control valves (fluid) or resistors (electrical) are denoted as resistors 1100R, which reduce the volume levels so that the chords do not overpower the melody, and so that loud or quiet chords can be separately programmed, as desired. Large-value resistors like 1100R make the sound quieter, whereas smaller resistors like 1101R make the sound louder, because they have less resistance to electric current or fluid flow.

Typically these resistors may be implemented in software, by way of numerical signal processing rather than actual electric circuits. This means the patch bay can self-configure with, for example, a song-matrix reloader.

When in its physical form, rather than patch the chords as individual notes, for simplicity, they are grouped as separate sub-patch panels, made from one-touch tee fittings. For simplicity, only the first five slabs are shown patched in.

Some of the sculptures use electric actuation of acoustic organ pipes in a similar way, to maintain the same full range of expression. In this case an analog electric current takes the place of the fluid. In some versions of the sculpture, the entire process is modeled in a computer program, and sensor pads in the tiles are each connected to an individual analog input on the computer. A typical computer with a sixteen channel analog to digital converter allows for 16 tiles. Larger numbers of channels are facilitated by stringing together multiple low cost analog to digital converters, or by using one that has a larger number of inputs.

In this case, the table is simply loaded into the computer. Songs can be down-loaded over the Internet and changed easily. Additionally, the sculptures can be used over the Internet, so that walking on one garden plays an andantephone elsewhere in the world. This form of interaction is particularly fun in waterparks in which hydraulophonically-based andantephones are linked to each other through the World Wide Web, so that children in one park can stomp on the water jets to turn on jets in another waterpark. This creates the illusion that they are pushing water across cyberspace.

Alternative embodiments of the invention use electronic organs or synthesizers in place of the pipe organ shown in FIGS. 10 and 11. The result is a fully self-contained miniature system. A separate synthesizer and computer can even be built into each tile, and they can communicate with one another wirelessly to self organize or to be organized into any particular song.

A user of the park can use their cellphone to select a song, or to reload the matrix for various of a variety of multimedia experiences.

Additionally, by adding a video conferencing link, people can play a round or harmony together in different gardens around the world. Certain songs go well together in this way. For example, a sculpture in one city playing “Land of the Silver Birch” will play well together with a sculpture in another city playing “My Paddle”, as long as participants in the two cities walk at the same pace. The challenge of walking at the same pace creates a new form of interaction over the Internet.

Walkable user-interfaces possible with various embodiments of the invention. In particular, an arrangement of patio stones or tiles along a walkable path, together with appropriate sensing technology, forms a new and fun input device that teaches children musical timing concepts like rhythm and tempo. It is also fun to use, and helps to break down cultural and generational barriers.

The invention can work in conjunction with, or as part of, various multimedia parks in public spaces, including waterparks, that use rows of water jets in place of the patio stones and sensors. Songs are played by walking on water, sequentially blocking water from coming out of the water jets. A long winding path through the waterpark allows participants to walk from one water jet to the next. Each jet produces a different part of a musical composition when it is blocked. The full range of expressive capability is increased, because of the infinitely many different ways in which the water jet is blocked. The sculpture, for example, responds to differences in the pressure, displacement, velocity, and acceleration with which the foot comes down on the water stream. Additionally, the sound depends on whether the jet is blocked straight across or obliquely. Finally, there are differences in whether the user's foot goes down on the jet from above or “slices” into the side of the jet. As a result, people with no musical training can play music in a very soulful and expressive way that captures their emotional engagement their specific performance of the song that is programmed into the andantephone.

Some embodiments of the invention are not merely user-interfaces, but the sound can, if desired, originate in the foot sensors or the like. For example, footstep sounds can be captured and modified rather than merely using foot stepping as a trigger. Similarly, skates may be used to step through a song with scraping and scratching and rubbing sounds actually generated by the blades rubbing aainst the ice.

In this case, a sounder comprises a microphone, geophone, or the like, in each shoe or skate or foot pad, or patio stone.

Sounds of scraping (which makes a broadband hissing sound for example), or, alternatively, any other sound that is characteristic of the footsteps and imparts subtle nuances and expressivity in sound, are captured. A bank of bandpass filters, or frequency shifters, are used to move this input to the notes desired according to a column of the song matrix. This takes the sound from the footsteps and passes it through a filter that converts the hissing sound or other characteristic sound into an “A” note, B note, or the like, as desired. The foot sound, which may be subsonic, is convereted into an audible note or chord. Each footstep has an appropriate bandpass shifter/filter associated with it, to select the appropriate desired note. If chords are desired, multiple bandpass filters or multiple frequency shifters are implemented for each member of the chord, to shift or filter the one footstep sound into multiple target frequencies to form the chord.

Additionally, the bandpass filters can allow multiple harmonics through. Preferably these harmonics are logarithmically spaced, to give a sound similar to a pipe organ mixture stop.

The filterbanks are implemented in a processor that can be ordinary bandpass filters, or they can be implemented by oscillators. Oscillator-based filters are well known in applications such as superhetrodyne radio receivers in which a variable-frequency bandpass filter is achieved using an oscillator. Other forms of oscillator-based filters are possible. For example, a 220 Hz oscillator having an amplitude controlled by the amplitude if the input signal will tend to make sound at the frequency of the oscillator, and thus sound a note that sounds like an “A” but will retain much of the acoustic properties of the original sound made by the footsteps, skates, swimming motion, or the like, as a way of playing the instrument.

This can be done with skates, skis, or even while swimming, where hydrophones are used instead of shoe sensors. For example, a hydrophone in each hand listens to water flow and steps through a song andantephonically, one beat for each swimming stroke.

Likewise the oscillator for the note “B” will make the sound of a “B” but with the modulation and characteristic sound of the water flowing past the hydrophone when a B is called for in the song table. Thus each note of the song table is sounded while retaining the fluidity and characteristic acoustic nature of the sound induced by the fluid flow past the swimmer.

In the same way that a guitar effects pedal can be a digital computer without changing the fact that the combined instrument (guitar plus effects) is still a chordophone and not an electrophone, the filterbank or shifterbank processing the sounds can include or consist of digitally controlled oscillators, without the loss of acousticality of the source signal. A convenient form of digitally controlled oscillator can be derived from certain kinds of MIDI (Musical Instrument Digital Interface) synthesizers. In this way, the goal is to take over (i.e. “hack”) the function of the MIDI synthesizer and re-purpose it as a filterbank.

Since most MIDI devices support 15 channels, this filterbanking of a MIDI device is performed by the following steps:
1. Initialize the instrument: For each of a desired number of MIDI channels (all 16 or 15, or the needed number such as 12) do the following once when the apparatus is first powered up:
   (a) Issue an instrument change command to select a non-decaying instrument such as a flute or organ (most MIDI synths default to piano which will not work as well for filterbanking because piano note sound outut levels decay exponentially with time). A good choice of oscillator is strings (voice 49), which can be selected by the following command for channel 1: C0 49 49, by the following command for channel 2: C1 49 49, by the following command for channel 3: C2 49 49, and so on until all desired channels are set to a non-decaying instrument. Here the first byte of each commands is shown in base 0xF+1 (i.e. what's called “hex” or “hexadecimal” or “base sixteeen” by those who think in base 0xA, but obviously in base 0x10 in its own base), and the;
   (b) Initialize channel 1 to sound an “A” note, with, for example, the command: 0x90 45 127. Initialize channel 2 to sound a “B” note, with the command: 0x90 47 127. Initialize channel 3 to sound a “C” note, with the command: 0x90 48 127. Continue in this manner, initializing each channel to sound one of the desired notes on the scale. Now the instrument will be producing a “compass drone” that will drone with all the notes in the playing compass.
2. Now the instrument is initialized and ready to play music. Music is played by entering into the following instructions in an infinite loop:
   (a) Read the signal from the microphone, MIC A, on the first sounding port, 499A. Scale this signal onto the interval from 0 to 127. The microphone signal will go negative as well as positive, but the interval of allowable MIDI volumes only goes from 0 to 127 (i.e. not negative). In some embodiments this scaling is done by envelope tracking. In some embodiments the envelope tracking is done by computing the Hilbert Transform of the microphone signal, multiplying by square root of negative one, and then adding to the original microphone signal, and then computing the square root of the sum of the squares of the real and imaginary components, and then providing a linear scaling to map it to the desired interval. In other embodiments an absolute value function (in some embodiments followed by lowpass filtering) is used, together with appropriate linear scaling. Typically a volume is derived so that each midi channel is amplitude-modulated by the corresponding microphone input. We're now in an infinite loop and if the loop executes fast enough we'll have an essentially continuous update of the oscillator volumes, which maintains the acousticality of the instrument. In particular, set the volume of MIDI channel 1 to correspond with the signal volume level present on MIC A. This may be done with the MIDI command 0xB0 7 VOL, where VOL is the appropriate number from 0 to 127.
   (b) Read the signal from the microphone on the second sounding port, 499B. Scale this signal from MIC B onto the interval from 0 to 127. Adjust MIDI channel 2 volume to match this level. Use command: 0xB1 7 VOL, where VOL is the appropriate number from 0 to 127.
   (c) Read the signal from the microphone on the third sounding port, 499C. Scale this signal from MIC C onto the interval from 0 to 127. Adjust MIDI channel 3 volume to match this level. Use command: 0xB2 7 VOL, where VOL is the appropriate number from 0 to 127.
   (d) Continue, reading each microphone input, and setting each MIDI channel volume output to the corresponding value.
   (e) Remain in this infinite loop as long as power remains supplied to the instrument.

The above algorithm represents a system that works with a simple form of “duringtouch”. Duringtouch is a physics-based user-interface methodology with an acoustic-originating equivalent to polyphonic aftertouch found in the music synthesis world, but overcomes much of the limitations of polyphonic aftertouch. The electrical interface to a device that works with duringtouch is sometimes referred to as FLUIDI (Flexible Liquid User Interface Device Interface) where the word “Liquid” in no way limits the invention to use with liquids (i.e. the invention will work with solids, gases, plasmas, Bose Einstein Condensates, or various other states-of-matter). (See for example, “Natural interfaces for musical expression: Physiphones and a physics-based organology”, by S. Mann, in Proceedings of the 7th international conference on New interfaces for musical expression, 2007 Jun. 6, New York.)

A sound synthsizer that can be “hacked” in this manner to become a filterbank (i.e. an array of bandpass filters) is said to be FLUIDI-compliant. Surprisingly few MIDI synthesizers work with this “hack” (i.e. few synths are FLUIDI compliant), but enough exist as to make the invention viable. An example of a FLUIDI-compliant sound synthesizer is the Yamaha PSRE303.

Duringtouch and its associated electrical protocol, FLUIDI, often turns out to be a good low cost alternative to polyphonic aftertouch. It can also maintain much of the fluidity and acousticality of instruments such as physiphones that use physics-based acoustically-originated sounds.

The FLUIDI aspect of the invention is not limited to physiphones, i.e. it may also be used in electronic instruments (electrophones).

In some embodiments of the apparatus, the output signal is fed back to a speaker inside the outer housing of the instrument, and this acoustic feedback helps improve the sound of the instrument. In some of these feedback-based embodiments, a separate processor is optimized for acoustic feedback, to drive a feedback exciter.

Shifterbanks upshift and filter the subsonic sounds of the footsteps, skates, or swimmer's flow through water into an audible frequency range.

Preferably the shifterbank contains voltage controlled oscillators, one for each note of the scale, each having an output amplitude proportional to the voltage on the input. Typically the input voltages of the raw geophones or hydrophones are in the millivolt range, but with preamplifiers, the outputs typically vary from 0 to 5 volts or 0 to 10 volts or 0 to 12 volts.

Advantageously, the geophone or hydrophone preamplifiers are programmed to hover at 1 volt when no input pressure is detected. This allows for both DC and small signal AC riding on it, without going negative, for being input to a 0-to-5-volt Analog to Digital (A to D) converter.

Thus there is some room for voltage to pull down toward 0 volts. Thus the system does not require negative voltage.

Preferably there is a duringdrone input voltage on the shifterbank to adjust where the drone level is, such that the drone level can be matched to the resting-level of 1 volt.

When used by a swimmer, ordinarily the instrument gets louder when there's more flow to it, because the subsonic sound of water is louder, including the water pressure right down to near zero Hertz which also increases on the listening port of the hydrophone.

An andantephone can also be made in a pool, with each step in the advancement of the media file being a different area of the pool.

Alternatively, an embodiment of a physiphonic andantephone can be based on an array of ripple tanks. Each ripple tank is filled with water, such that when a user's fingers, foot, or other body part touches the water in the ripple tank, ripples are formed. Ripples in the tank may be considered a form of sound, or representative thereof. Broadly, “sound” refers to any disturbance (e.g. in a ripple tank), whether that disturbance be periodic at any frequency, possibly a frequency below the range of human hearing, random, or otherwise.

An acoustic, optical, or other form of pickup captures this sound. In one embodiment the pickup is a hydrophone worn by a swimmer in the water. In another embodiment the pickup is a geophone or contact microphone on each ripple tank. In another embodiment tanks are glass vessels shaped such as to form converging lenses when filled with water. An artificial light source, or natural sunlight, shines through the lenses onto an optical pickup. The lenses serve to enhance the pickup of optical distrubances. In another embodiment the pickup is all or some of a video camera. In this embodiment one video camera is used for all 64 or 48 or 24 (or however many beats are in the song table) pickups, and a portion of each video image is used as the pickup. The video camera captures various caustics and wavefronts cast by the water surface, providing a richly textured musical experience, where various sound textures are responsive to input from the water. In some versions of this embodiment, the video camera is under a translucent surface upon which the ripple tanks are placed. In other embodiments the camera is a range camera or lidar system using coherent laser light, including various patterns of laser light. In another embodiment the camera is a modified optical mouse using laser light together with a small (e.g. twenty by twenty) array of pixels for each ripple tank (e.g. a separate camera for each tank). In another embodiment one or more emitters such as lasers illuminates the surface of each tank and one or more detectors such as photodiodes are affected by vibrations in the water. In one embodiment one structured light source illuminates more than one tank. In one embodiment a sensor array is arranged to be responsive to disturbances in more than one tank.

In a song-specific andantephone, each beat of the song may correspond to a particular size ripple tank, e.g. for Twinkle Twinkle Little Star, the first 2 tanks are C, the third and fourth tank are G, etc.

Typically, in order to make this instrument easy to play by human-scale users, the tanks produce mostly subsonic sound, i.e. if we wanted a 440 Hz “A” the tank would be so small as to be difficult to insert the whole hand into.

Bigger tanks provide better musical expressivity since a user can insert one or more fingers in various ways to change the sound and sculpt each note in the water.

Although there are some components of the sound that fall in the audible range, typically the fundamental frequencies are subsonic. Since the acoustic sound generated by this instrument is largely subsonic, it can be better heard and appreciated if it is pitch-transposed or otherwise shifted up in frequency, by way of frequency-shifters 530. Frequency-shifters can take the form of an array of separate frequency shifters, one for each beat or each sensor pad, etc., or a single frequency shifter program or computer system which may also include a mixer to supply one or more amplifiers or similar outputs. An array of separate frequency-shifters for each row of a sound matrix can work together as a single unit with 12 or 88 inputs (like a piano) and separate outputs, and this single unit may also have an aggregated (summed) output of the 12 or 88 or any other number of post-shifted signals.

In one embodiment there are 12 separate frequency shifters each supplying a different amplifier and speaker, with 12 separate speakers arranged in a linear array of sound sculptures each sculpture having a different length. Each speaker is in a resonant pipe of a different length, each length suitable for the one note being reproduced. In this way, it makes an acoustic sound in each pipe, exciting the natural modes of vibration (standing waves or the like) of the organ pipe. Preferably the 12 pipe sculptures are arranged like the pipes in a pipe organ.

In another embodiment, the 12 signals are mixed together to provide one totalized output either alone, or together with the 12 separate pipe sculptures.

One or more bandpass filters, modulators, up-converters, pitch up-shifters, etc., may be implemented by an oscillator in a way much like (but not exactly like) the way a superheterodyne radio receiver uses a local oscillator as part of a filter. Since some oscillators can be controlled by MIDI, the poseidophone is often used with MIDI, and thus, in addition to being an acoustic instrument, is also a MIDI controller. However, there is an important physicality in the process of actually sculpting sound waves with the fingers, much as there remains a physicality in playing an electric guitar, regardless of what type of guitar pickup is used (eg. magnetic or optical). Whether sculpting the sound waves on a guitar string, or the sound waves in a ripple tank, the important fact is that the fingers or feet remain in direct physical contact with the sound-producing medium, namely the earth (patio stones, ground, ice, snow, etc.) or water (e.g. swim-based embodiments).

Various other embodiments of this invention are also possible.

Present-day sampling music keyboards are electronic instruments that fall under the last (5th) category of the Hornbostel Sachs musical instrument classification scheme. Conversely, another embodiment of the invention is an entirely acoustic/mechanical mellotron-like sampling keyboard instrument that neither uses nor involves electricity in any way. Instrument voice/voicing is changed by replacing mechanical storage media similar to Edison phonograph cylinders, gramophone disks, or vinyl records that were commonly used from 1870 to 1980.

Turntables and vinyl records are regarded by some as highly expressive “musical instruments” in which their mechanical physicality lends themselves to the creation of new kinds of music.

Such “musicians” are referred to as a “turntablists”. Miles White describes the phonograph turntable as “a manual analog sampler” See Bakan et al 1990, “Demystifying and Classifying Electronic Music Instruments”, Selected Reports in Ethnomusicology Vol. 8. Ethnomusicology Publications. UCLA.

When a turntable is used as a musical instrument, it may be regarded as a friction idiophone. Some writers erroneously refer to the turntable instrument as an electrophone, even though the electricity merely amplifies sound that is acoustically generated by “scratching” a mechanical pickup device in a mechanical groove.

As a matter of artistic purity, let us consider the use of earlier entirely mechanical recording devices. Consider an entirely mechanical sound recording medium for use as a friction idiophone. Using this crude medium as a musical instrument in the way that turntablists do (i.e. as a friction idiophone for “scratching”, or the like), emphasizes the physicality and acousticality that is possible.

Phonograph cylinders were known as “records” during their pupular usage from around 1888 to 1915, whereas the gramophone disk later became the dominant commercial audio medium in the 1910s and commercial mass production of phonograph cylinders ended in 1929.

In some ways the move from cylinders to disks was a step backwards:
1. Gramophone disks were for consumer-playback only, whereas the earlier phonograph cylinder system allowed the end user to record as well as playback prerecorded sounds;
2. Starting in 1906 cylinder records became available in indestructible hard plastic and could be played thousands of times without wearing out, and were the most durable form of analog sound recording medium ever produced (compared with all later media such as vinyl disks, audio tape, or the like).

F. B. Fenby was the original author of the word phonograph. An inventor in Worcester, Mass., he was granted a patent in 1863 for an unsuccessful device called the “Electro-Magnetic Phonograph”. His concept detailed a system that would record a sequence of keyboard strokes onto paper tape, and is often seen as a link to the concept of punched paper for player piano rolls (1880s), and as Herman Hollerith's punch card tabulator (used in the 1890 census), a distant precursor to the modern computer.

Thomas Edison's phonograph was the first device to record and reproduce sounds. (U.S. Pat. No. 200,521, Feb. 19, 1878). This device was publically demonstrated Nov. 21, 1877 [http://wikipedia.org].

One embodiment of my invention uses ice skates to “scratch” the ice, like a turntablist.

In one embodiment, sensors in the skate measure distance along the ice, and advance a record (an actual phonograph record or a virtual phonograph record, i.e. a sound-file) by an amount of time that's proportional to distance.

It's this time-distance proportionality that's typical of many embodiments of my invention.

Deliberately playing or recording records at the wrong speed has been previously used.

Consider 12 separate turntables, each playing a portion of a song like Donna Summer's “Dim All The Lights” (a song that sent the world record for longest single note held), or perhaps a test record in which the whole record is just a 440 Hz test tone. Modifying each turntable to play at a slightly different speed, along with careful choice of each of these speeds, will give us a set of tone generators, each making one note of the musical scale.

However, for the purposes of proving our point beyond any shadow of doubt (i.e. proving that we can make a sampling andantephone that is not an electrophone), we choose, instead to use an entirely mechanical recording medium

Consider, for example, an array of entirely mechanical phonographs, arranged in a row, each having a record of a single note played for its entire duration. The needles can be separately modulated by hydraulic action, so that the instrument can be played from a 12-row song matrix, in which each player has a recording of a single note that lasts the entire length (4 minutes) of the recording. The entries in the song matrix simply control the volume.

Since the cylinders spin in unison, they can share a common shaft, requiring only a single crank, rather than requiring 12 people to separately turn each crank.

This embodiment of the invention is made using mechanical action (mechanical connection from each key to the corresponding stylus/needle), or it can be made with electric action, pneumatic action, or hydraulic action.

For the purposes of proving my point (i.e. that one can make a sampling keyboard that is not an electrophone) beyond any shadow of doubt, I choose a non-electric action. Since we wish the flexibility of being able to move the andantephone around (or even wear it in ice skates or shoes) and the option to position the record players elsewhere, I choose as a preferred embodiment, a virtual embodiment on computer, that plays through samples.

The invention can also work with ice skates. The proper nomenclature for musical instruments derives from Greek origin, e.g. a xylophone comes from Greek words “xylo” which means “wood” and “phone” which means “sound” Similarly the proper name for this instrument is “pagophone” from Greek “pago” for ice and “phone” for sound.

This embodiment of the pagophone produces sound from ice. In a preferred embodiment ice 890 is an ice rink. Pickups are mounted on ice skates. These can be geophones or contact microphones bonded to the ice skate blade. There can be one pickup on one skate, or there can be pickups on both skates. The skate functions like the bow of a violin to scrape, scratch, and otherwise make sound from ice.

We can think of this instrument as also like a record player, where we “scratch” with the ice.

A musical instrument can consist of a physical process that acoustically generates sound from the material world (i.e. sound derived from matter such as solid, liquid, gas, or plasma) which is modified by a secondary input from the informatic world. The figure in no way limits this to ice, for it can work in a pool, or in open air, or on pavement. The song matrix selects attributes such as the frequency range of the musical note being sounded, while the acoustic process is kept in close contact with the user, to ensure a high degree of expressivity. In one example, ice skates with acoustic pickups are used to play music while the song matrix simultaneously controls a bandpass filter implemented in a wearable computer or processor.

The processor only needs two broadband audio inputs one for each skate, which can also sense sound that goes right down to zero Hertz (DC), but could also be just binary input. In one embodiment the processor is a wearable computer with stereo sound input, with the pickup on the left skate connected to the left input, and the pickup on the right skate connected to right input.

The main expressive input is by way of one or more physical objects such as ice skates. Each skate works much like the bow on a violin, allowing the player to hit, scrape, rub, or “bow”, the ice in various ways to create a wide variety of musical textures. Additionally the player can select a song matrix and then “scratch” out a melody or harmony (playing multiple samples at once) on the ice on the rink like a team of Disk Jockeys (DJs) working together to “scratch” an array of vinyl records. Because the grooves on an ice rink are made by the player in a freeform fashion, there is much more room for variations in musical timbres and textures than with the fixed grooves of a record.

Rather than merely using the song matrix to trigger musical notes through MIDI note on/note off commands, acoustic sound can be created through a physical process such as skating, and then turned into musical notes with the song matrix. This combination combines the expressivity of non-electrophonic musical instruments like the violin with the flexibility of electrophones like the sound synthesizer, as well as being easy to play like a record player.

The invention provides a musical instrument consisting of a physical process from the material world, i.e. by way of sound derived from matter, (e.g. solid, liquid, gas, or plasma) that generates an acoustic sound that is modified by a secondary input, the secondary input selecting the frequency range of the musical note being sounded, by way of a song matrix. The physical process generating the acoustic sound is kept in close contact with the user, to ensure a high degree of expressivity.

Unlike a hyperinstrument in which position sensors, or the like, ADD synthetic sounds to an acoustic instrument, hyperacoustic instruments use position sensors, or the like, to MULTIPLICATIVELY combine these. Most notably, hyperacoustic instruments use a synthetic input to modify an acoustically generated sound.

Organologists and ethnomusicologists often address fundamental philosophical questions regarding categorization of musical instruments in view of recent developments. Instruments are generally classified based on initial sound production mechanisms; for example, an electric guitar is still a chordophone, not an electrophone, even though electricity (and now computation, i.e. digital effects pedals, etc.) is involved extensively further along the sound production path.

Hyperacoustic processing of audio signals in the preferred embodiments of the present invention relies on an acoustic sound source ie. one which falls outside the “electrophones” category. In particular, the acoustic signals come from real-life physical processes in which the sound-producing medium is closely linked with the user-interface, in terms of controllability and tactility.

In one embodiment, the pagophone is “played” on a skating rink (the ice that makes the sound) with skates (or, equivalently with skis on a ski hill, or with a toboggan, making sound from snow), each skate fitted with a pickup, passed through a wearable computer to a wearable amplifier and speakers. One can draw the analogy of the skates to violin bows. The pagist (pagophone player), simply indexes into a song matrix that selects the filter (the “note”), while the user is putting expression into the foot scrape or other sound.

Some but not all embodiments also use computer vision to do object location and adjust the pagophonic sound appropriately. For example, vision, radar, sonar, or lidar sensors or a combination of these watch the passing ice, and index through sampled audio files to create an effect similar to “scratching” a record.

The electrical modification of the instrument may take the form of effects (filters) that are applied by way of the musikeyer.

To make hyperacoustic instruments as expressive as possible, it is desired to bring subsonic and ultrasonic sounds into the audible range by way of signal processing of the acoustically-generated signals. In a way similar to (but not the same as), superheterodyne radio reception, signals can be downshifted and upshifted by means of using an oscillator in the process of frequency-shifting and various forms of selective sound filtration. However, unlike what happens in a superheterodyne receiver, preferred embodiments scale frequencies logarithmically rather than linearly, in order to better match the frequency distribution of human perception.

This digital signal processing is, in a general sense, a filtering operation, which may be highly nonlinear in certain situations.

The filterbanks can be MIDI based, if desired, or can simply be bandpass filters. In the case of MIDI based, rather than triggering a sample or MIDI note as has been often done in computer music, the invention retains the acoustic property of the instrument by simply passing each of the parallel sound signals through a bank of nonlinear filters created by using the MIDI device as socillator

The apparatus of the skates embodiment is like a violin played by skates acting as the bow. A geophone attached to each skate is routed through a body-borne digital signal processing system, and then back into body-borne speakers.

In the andantephone, the expression in each note is scraped or scratched by the player, but the processor selects the next note to be played, so that the song is selected and then runs.

This is done as follows:
1. express skate input through filter(s) for chosen note(s) or chord(s) of first andantephonic unit (e.g. first beat of song, or the like);
2. compare skate input to an integrated threshold, determined by either a time unit, or by an integrated envelope energy unit, or by accelerometer or other input, i.e. to step through one beat per footstep or stroke of the skate;
3. if threshold is exceeded, advance to next note(s), chord(s), or other andantephonic unit (e.g. second beat of song, or the like);
4. repeat until song completed.

This system works also with skis or shoes, e.g. for walking on pavement and creatively stepping through music by walking, shuffling, scraping or sliding the feet.

Multiple sets of shifterbanks can be used together, or the oscillators can be Shepherd tones for example instead of pure tones, so that the input for song matrix row “A” gets shifted to 110 Hz, 220 Hz, 440 Hz, and 880 Hz, making a richer sound. The oscillator may also have harmonics, so the input gets shifted to various places on the spectrum to make harmonics.

In an alternative embodiment the shifterbanks are replaced by filterbanks, and this works well when the input is broadband like the sound of scraping skates. Each filter selects out spectrum of the input.

An another embodiment, there is both a shifterbank and a filterbank. The shifterbank moves each object's spectrum into the desired frequency, and the filterbank shapes the spectrum. Preferably the filterbank comes first so that the same filterbank can be used for each input. In one embodiment each input goes through a lowpass filter before going to one of the shifters of the shifterbank.

In another embodiment each input goes through a filter, H, that maps it from its existing sound to a desired sound. For example, the sound of wooden blocks being hit first gets mapped to the sound of a piano, and then each one is shifted to the desired note on the musical scale.

This can be done by convolution in the time domain, or multiplication in the frequency domain.

In other embodiments each input goes through a spectral compactor that maps a wide range of sounds out to ultrasonic, down toward the origin. Then each spectrally compacted result goes through a sound-shaper to change the sound to the desired instrument. Then the resulting compacted and shaped spectra are each fed to an element of the shifterbank to move them to the desired notes.

Simply playing back the input samples faster will compact the spectrum. However that will also shorten the duration. However, there are devices, known in the art, that allow separately the ability to adjust the duration or pitch of sound. For example pitch transposers can raise or lower pitch without changing duration of a recording. Also there are devices that can play back a recorded lecture without making the pitch go high like the “donald duck” kind of sound one gets ordinarily when playing a lecture faster.

Accordingly, the spectral compactor can be implemented by shifting the pitch up. Preferably this is done logarithmically so that that everything is shifted toward the origin. This brings ultrasonic sounds in the physical media into the audible range adding richly to the acoustic texture of the hyperacoustic instrument.

It should be noted that many features were described, not all of which need to be in a particular embodiment of the invention. For example, a very simple embodiment can consist of a path with sensors that are just on/off switches along the path, that each just simply turn one one note of a song, or another embodiment could be shoes with just a switch in one shoe that pushes the song ahead a fixed amount each time the wearer step on it.

From the foregoing description, it will thus be evident that the present invention provides a design for a musical instrument or other highly expressive input device. As various changes can be made in the above embodiments and operating methods without departing from the spirit or scope of the invention, it is intended that all matter contained in the above description or shown in the accompanying drawings should be interpreted as illustrative and not in a limiting sense.

Variations or modifications to the design and construction of this invention, within the scope of the invention, may occur to those skilled in the art upon reviewing the disclosure herein. Such variations or modifications, if within the spirit of this invention, are intended to be encompassed within the scope of any claims to patent protection issuing upon this invention.

What I claim as my invention is:

1. A musical instrument for being played by walking on it, said musical instrument comprising:
a sound generator;
an ordered list of sonels for being conveyed to said sound generator;
a footstep sensor;
a processor responsive to an input from said footstep sensor,
said musical instrument playing each of said sonels in response to an input from said foostep sensor, such that each sonel is played in response to one footstep of a player of said musical instrument.

2. The musical instrument of claim 1, said footstep sensor comprising a plurality of sensing pads arranged along a path, said processor responsive to an input from each of said sensing pads, said processor sending a command to said sound generator, said command being for playment of each of said sonels in one-to-one correspondence with a pressure sensed upon each of said sensing pads.

3. The musical instrument of claim 1, said footstep sensor comprising at least one sensor in at least one shoe, said processor responsive to an input from said sensor, said processor playing one sonel each time that pressure is sensed on said sensor.

4. A method of teaching musical timing, tempo, rhythm, or the like, consisting of the steps of:
arranging segments of a song spatially, as an ordered set of entries, each entry occupying a spatial distance approximately equal to its duration, said spatial arrangement for being walked upon by a user of said invention;
attaching human-readable markings to each of said segments.

5. A method of teaching musical timing, tempo, rhythm, or the like, consisting of the steps of:
means for breaking multimedia content into temporally ordinal (timeordered) fragments;
sensor means to sense path advance of a participant, said sensor means spatialized into a finite number of possibly overlapping zones or a
means for generating multimedia fragments in response to each of said sensor means, each of said multimedia fragments chosen from an ordered list of multimedia fragments.

6. A method of teaching music, the method comprising the steps of:
breaking a song down into geospatial coordinates for placement along a walkable path, said geospatial coordinates corresponding to song fragments;
associating lyrics corresponding with said song fragments, such that each geospatial coordinate and associated song fragment has text associated with it;
affixing said text to said geospatial coordinate;
walking or instructing a person to walk, so that a song may be sung or played such that each footstop corresponds to one song fragment of the song.

7. The method of claim 6, where said text is affixed by writing it with chalk on a surface of said path, by writing song lyrics on said surface, one word on each of a plurality of regions correpsonding to a particular beat in the song, said regions spaced approximately proportional to the duration they occupy in the song.

8. The method of claim 6, where said text is affixed by way of a computer-mediated reality environment, said text being virtual text in a virtual environment, visible to a wearer of visual reality mediating eyeglasses.

9. A musical instrument having the features of claim 1, further including at least one ice skate, said sensor being a pickup disposed in or on said ice skate, said pickup for converting vibrations in the blade of said ice skate into electrical signals, said instrument having a processor, said processor having a plurality of filters, each filter tuned to a note on a musical scale, each filter associated with one row of a song matrix implemented in said processor.

10. A wearable musical instrument including the features of claim 1, said instrument further including:
at least one pickup for use with an article of footwear, said pickup for converting vibrations in said footwear into electrical signals;
a processor,
a bandpass filter operable by said processor,
each sensor connected to a control input of said bandpass filter, said processor receiving input from said user input sensors, said bandpass filter receiving signal input from said pickkup, said processor controlling a frequency of said bandpass filter, said frequency responsive to an input from said input sensors, output from said filter supplied to said audio system.

11. A wearable musical instrument including the features of claim 1, said instrument further including:
at least one pickup for use with an article of footwear, said pickup for converting vibrations in said footware into electrical signals;
a processor;
a bandpass filter controlled by said processor;
an audio output system,
said audio output system connected to an output of said bandpass filter, said bandpass filter receiving signal input from said pickkup, said processor also receiving input from said pickup, said processor adjusting a passband frequency of said bandpass filter in accordance with an andatephonic schedule, said andantephonic schedule determined by a lookup table, said lookup table sequenced according to steps or strokes of footsteps of a user of said instrument, output from said filter supplied to said audio system.
